(19) United States
(12) Patent Application Publication
(10) Pub. No.: US 2026/0143307 A1
(43) Pub. Date: May 21, 2026

(54) VEHICLE DATA PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Zhongyang SUN, Shenzhen (CN)

(21) Appl. No.: 19/450,496

(22) Filed: Jan. 15, 2026

Related U.S. Application Data
(63) Continuation of application No. PCT/CN2024/114283, filed on Aug. 23, 2024.

(30) Foreign Application Priority Data
Oct. 30, 2023 (CN) 202311434073.7

(51) Int. Cl. H04W 4/029; G01C 21/20; G06V 20/58

(52) U.S. Cl. CPC H04W 4/029; G01C 21/20; G06V 20/586

(57) ABSTRACT

This application relates to a vehicle data processing method including inputting a sensor signal generated by a vehicle sensor of a target vehicle to a preset state machine; updating a shared signal set based on a received sensor signal by using the preset state machine in a current vehicle state of the target vehicle, determining a next vehicle state of the target vehicle based on a current shared signal set, and switching from the current vehicle state to the next vehicle state; and updating a private signal set corresponding to the target parking state based on the received sensor signal by using the preset state machine when switching to a target parking state, and determining parking information of the target vehicle based on the current shared signal set and a current private signal set, the parking information being configured as vehicle finding guidance information of the target vehicle.

### RELATED APPLICATIONS

This application is a continuation of PCT Application No. PCT/CN2024/114283 filed on August 23, 2024, which claims priority to Chinese Patent Application No. 2023114340737, filed to China National Intellectual Property Administration on October 30, 2023 and entitled "VEHICLE DATA PROCESSING METHOD AND APPARATUS, COMPUTER DEVICE, AND STORAGE MEDIUM", which are both incorporated herein by reference in their entirety.

### FIELD OF THE TECHNOLOGY

This application relates to the field of computer technologies, and in particular, to a vehicle data processing method and apparatus, a computer device, a storage medium, and a computer program product.

### BACKGROUND OF THE DISCLOSURE

With the development of technologies, more and more people use vehicles as a means of transportation. While vehicle travel offers convenience, it is often difficult to locate parked vehicles.

Often, a user needs to manually take a photograph to record a parking position, and subsequently finds the vehicle according to the photograph. However, the user manually photographing the parking position for every parking event is time-and-labor-consuming, and it is also time-and-labor-consuming for the user to find vehicles according to photographs. Therefore, it is desirable to improve the method for finding a vehicle.

### SUMMARY

Embodiments of this application provide a vehicle data processing method and apparatus, a computer device, a computer-readable storage medium, and a computer program product.

This application provides a vehicle data processing method, applied to a computer device, and including inputting a sensor signal generated by a vehicle sensor of a target vehicle to a preset state machine, the preset state machine comprising a logical relationship among a plurality of vehicle states; updating a shared signal set based on a received sensor signal by using the preset state machine in a current vehicle state of the target vehicle, determining a next vehicle state of the target vehicle based on a current shared signal set, and switching from the current vehicle state to the next vehicle state, the shared signal set comprising sensor signals shared by vehicle states; and updating a private signal set corresponding to the target parking state based on the received sensor signal by using the preset state machine when switching to a target parking state, and determining parking information of the target vehicle based on the current shared signal set and a current private signal set, the parking information being configured as vehicle finding guidance information of the target vehicle.

This application provides a vehicle data processing method, applied to a terminal, and including displaying a parking notification corresponding to a target vehicle; and displaying vehicle finding guidance information of the target vehicle in response to a trigger event for the parking notification; the vehicle finding guidance information being determined when switching to a target parking state, by updating a shared signal set and a private signal set corresponding to the target parking state based on a received sensor signal by using a preset state machine that controls vehicle state switching, and based on a current shared signal set and a current private signal set, the preset state machine comprising a logical relationship among a plurality of vehicle states, and the shared signal set comprising sensor signals shared by the vehicle states.

This application further provides a computer device, including a memory and a processor, the memory having computer-readable instructions stored therein, and the processor, when executing the computer-readable instructions, implementing operations in the foregoing vehicle data processing method.

This application further provides a non-transitory computer-readable storage medium, having computer-readable instructions stored therein, the computer-readable instructions, when executed by a processor, implementing the operations in the foregoing vehicle data processing method.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe the technical solutions of embodiments of this application or related technologies more clearly, the following briefly introduces the accompanying drawings required for describing embodiments or related technologies. Apparently, the accompanying drawings in the following descriptions show only some embodiments of this application, and a person of ordinary skill in the art may still derive other drawings based on these accompanying drawings without creative efforts.

FIG. 1 is an application environment diagram of a vehicle data processing method in an embodiment.

FIG. 2 is a schematic flowchart of a vehicle data processing method in an embodiment.

FIG. 3 is a schematic flowchart of determining parking information of a target vehicle in an indoor parking state in an embodiment.

FIG. 4 is a schematic diagram of switching among various vehicle states in an embodiment.

FIG. 5 is a schematic interface diagram of a vehicle data processing method in another embodiment.

FIG. 6 is a schematic interface diagram of entering a vehicle finding guidance interface through a parking notification in an embodiment.

FIG. 7 is a schematic interface diagram of a vehicle finding guidance interface in an embodiment.

FIG. 8 is a schematic interface diagram of playing a parking video in an embodiment.

FIG. 9 is a schematic interface diagram of paying a parking fee in an embodiment.

FIG. 10 is a schematic interface diagram of a parking fee surcharge setting entrance in an embodiment.

FIG. 11 is a schematic interface diagram of setting a parking fee surcharge reminder condition in an embodiment.

FIG. 12 is a schematic interface diagram of a vehicle finding guidance interface of a vehicle terminal in an embodiment.

FIG. 13 is a schematic interface diagram of a vehicle finding guidance interface of a vehicle owner terminal in an embodiment.

FIG. 14 is a structural block diagram of a vehicle data processing apparatus in an embodiment.

FIG. 15 is a structural block diagram of a vehicle data processing apparatus in another embodiment.

FIG. 16 is a diagram of an internal structure of a computer device in an embodiment.

### DESCRIPTION OF EMBODIMENTS

To make the objectives, technical solutions, and advantages of this application clearer, the following further describes this application in detail with reference to the accompanying drawings and the embodiments. The specific embodiments described herein are only used for explaining this application, and are not used for limiting this application.

Embodiments of this application may be applied to various scenes, including but not limited to a cloud technology, artificial intelligence (AI), intelligent transportation, and assisted driving.

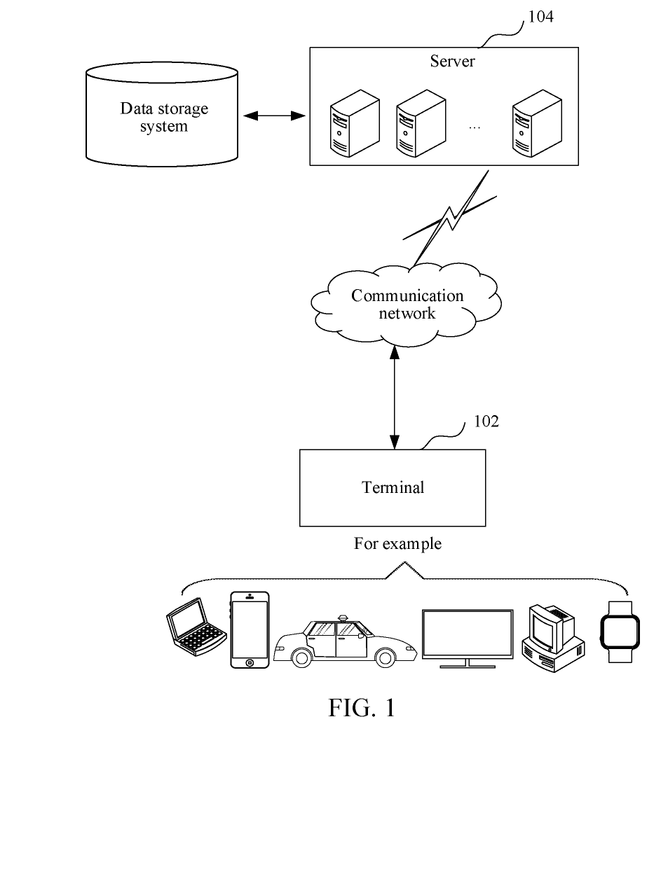

A vehicle data processing method according to an embodiment of this application may be applied to an application environment shown in FIG. 1. A terminal 102 is in communication with a server 104 through a network. A data storage system may store data to be processed by the server 104. The data storage system may be integrated on the server 104, or placed on a cloud or other servers. The terminal 102 may be, but is not limited to, various personal computers, notebook computers, smartphones, tablet computers, Internet of Things devices and portable wearable devices. The Internet of Things devices may be smart speakers, smart televisions, smart air conditioners, smart in-vehicle devices, and the like. The portable wearable device may be a smart watch, a smart band, a head-mounted device, or the like. The server 104 may be implemented by using an independent server, or a server cluster that includes a plurality of servers, or a cloud server.

Both the terminal and the server may be separately configured to execute the vehicle data processing method provided in the embodiments of this application. That is, the computer device may be separately configured to execute the vehicle data processing method provided in the embodiments of this application, and the computer device may be a terminal, or may be a server. Certainly, the server and the terminal may further be cooperatively configured to execute the vehicle data processing method provided in the embodiments of this application.

For example, a preset state machine is set on the terminal. The terminal inputs a sensor signal generated by a vehicle sensor of a target vehicle to the preset state machine, the preset state machine including a logical relationship among a plurality of vehicle states. The terminal updates, in a current vehicle state of the target vehicle, a shared signal set based on a received sensor signal by using the preset state machine, determines a next vehicle state of the target vehicle based on a current shared signal set, and switches from the current vehicle state to the next vehicle state, the shared signal set including sensor signals shared by vehicle states. The terminal updates, when switching to a target parking state, a private signal set corresponding to the target parking state based on the received sensor signal by using the preset state machine, and determines parking information of the target vehicle based on the current shared signal set and a current private signal set, the parking information being configured as vehicle finding guidance information of the target vehicle. The terminal may display the parking information. The terminal may directly transmit the parking information to another terminal, or the terminal may transmit the parking information to another terminal by using the server, and another terminal displays the parking information.

For example, a preset state machine is set on a smart in-vehicle device, and the smart in-vehicle device determines the parking information of the target vehicle by using the preset state machine. The smart in-vehicle device transmits the parking information to the server, and the server transmits the parking information to a smartphone, a computer, or a portable wearable device of a vehicle owner.

For example, the terminal displays a parking notification corresponding to the target vehicle, and displays, in response to a trigger event for the parking notification, the vehicle finding guidance information of the target vehicle.

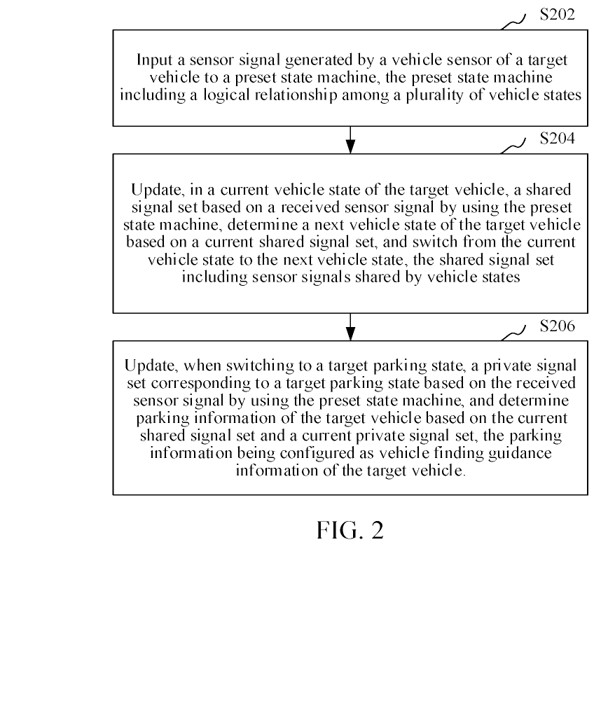

In an embodiment, as shown in FIG. 2, a vehicle data processing method is provided. With a case that the method is applied to the terminal in FIG. 1 as an example, description is provided. The method may be performed by the terminal or the server alone, or may be performed through interaction between the terminal and the server. Where:

Operation S202: Input a sensor signal generated by a vehicle sensor of a target vehicle to a preset state machine, the preset state machine including a logical relationship among a plurality of vehicle states.

The target vehicle may be any vehicle. Various vehicle sensors are arranged on the target vehicle, and are configured to collect various pieces of operating condition information during vehicle operation, for example, a vehicle speed, a GPS signal, and a gear signal. The vehicle sensor may alternatively be referred to as an in-vehicle sensor.

A state machine is an abstract mathematical model, and represents behavior of a type of system or program. The preset state machine is a state machine preset for intelligent vehicle finding. The preset state machine includes a logical relationship among a plurality of vehicle states. A vehicle state refers to a state reflecting a specific vehicle behavior in a vehicle operation and parking process. For example, vehicle states include an initial state, a parking state, and a stopping state. The logical relationship is configured for describing a transfer condition among various vehicle states, and the preset state machine may control switching or transferring among vehicle states based on the logical relationship.

In an embodiment, the preset state machine includes three parts: a state set, a transfer function, and an initial state. The state set represents all vehicle states that may exist in an intelligent vehicle finding system, the transfer function describes a process in which the intelligent vehicle finding system transfers from a vehicle state to another vehicle state, and the initial state represents an initial state of the intelligent vehicle finding system. The intelligent vehicle finding system refers to a system or program that automatically analyzes, according to a set program and algorithm, data generated in real time by an in-vehicle sensor in a vehicle operation and parking process, and obtains, through analysis, vehicle parking information configured for vehicle finding.

Specifically, in a when a target vehicle is running, a vehicle sensor of the target vehicle outputs a related sensor signal in real time. The terminal inputs a sensor signal generated in real time by the vehicle sensor of the target vehicle to the preset state machine, controls vehicle states switching by using the preset state machine, and generates parking information of the target vehicle during parking, so that a user can find a vehicle quickly based on the parking information when required. The preset state machine controls vehicle state switching based on a received sensor signal, and generates parking information of the target vehicle in the parking state based on the received sensor signal.

In an embodiment, the terminal is a target vehicle. A preset state machine is set on the target vehicle. The target vehicle inputs a sensor signal generated in real time by the vehicle sensor to the preset state machine, controls vehicle state switching by using the preset state machine, and generates parking information of the target vehicle during parking.

Operation S204: Update, in a current vehicle state of the target vehicle, a shared signal set based on the received sensor signal by using the preset state machine, determine a next vehicle state of the target vehicle based on a current shared signal set, and switch from the current vehicle state to the next vehicle state, the shared signal set including sensor signals shared by vehicle states.

The current vehicle state is a current state of the vehicle. When the intelligent vehicle finding system is started, the current vehicle state is an initial state.

The shared signal set includes sensor signals shared by vehicle states. Sensor signals shared by vehicle states may be sensor signals required for data processing in the vehicle states. The vehicle states may share at least one sensor signal. For example, the sensor signals shared by the vehicle states include at least one of sensor signals such as a vehicle positioning signal, a vehicle motion signal, and a vehicle camera image. The vehicle positioning signal is a GPS signal of the vehicle. The vehicle motion signal is a sensor signal reflecting motion of the vehicle, for example, the vehicle motion signal may be a vehicle speed. The vehicle camera image refers to an image acquired by an in-vehicle camera.

The current shared signal set is a latest shared signal set. The current shared signal set includes latest sensor signals shared by the vehicle states.

Specifically, the preset state machine may control vehicle state switching based on the shared signal set. The terminal updates, in a current vehicle state of the target vehicle, a shared signal set based on a received sensor signal by using the preset state machine, determines a next vehicle state of the target vehicle based on a current shared signal set, and switches from the current vehicle state to the next vehicle state. The preset state machine includes switching conditions among the vehicle states. In the current vehicle state of the target vehicle, if the current shared signal set meets a switching condition of a vehicle state, the next vehicle state of the target vehicle is determined to be the vehicle state.

For example, the shared signal set may store a sensor signal representing whether the vehicle stops. If the current shared signal set includes a signal indicating that the vehicle stops, the next vehicle state of the target vehicle is determined to be a stopping state.

Operation S206: Update, when switching to a target parking state, a private signal set corresponding to a target parking state based on the received sensor signal by using the preset state machine, and determine parking information of the target vehicle based on the current shared signal set and a current private signal set, the parking information being configured as vehicle finding guidance information of the target vehicle.

The parking state indicates a state of the vehicle in a parking process. If the preset state machine includes at least one parking state, the target parking state may be any one of the parking states. For example, if the preset state machine includes an initial state, an indoor parking state, an outdoor state, and a stopping state, the target parking state may be the indoor parking state. For another example, if the preset state machine includes an initial state, an indoor parking state, an outdoor parking state, and a stopping state, the target parking state may be the indoor parking state, or may be the outdoor parking state.

A key of the intelligent vehicle finding system is to determine parking information of the vehicle. To obtain accurate parking information, a private signal set is set for the target parking state. The private signal set corresponding to the target parking state includes sensor signals private to the target parking state. For example, in the target parking state, it is necessary to record a vehicle rear-camera image to identify a parking space. In another vehicle state, it is not necessary to specially record the vehicle rear-camera image, so that the private signal set corresponding to the target parking state includes the vehicle rear-camera image. The current private signal set refers to a latest private signal set. The current private signal set includes latest sensor signals private to the target parking state.

The parking information of the target vehicle is information related to a parking behavior of the target vehicle. For example, the parking information may include at least one type of information such as a parking lot, a parking floor, a parking space, a parking start time, a parking video, and a parking fee. The parking information of the target vehicle is configured as vehicle finding guidance information of the target vehicle, and a user may find the target vehicle quickly based on the vehicle finding guidance information of the target vehicle.

Specifically, the vehicle states include a target parking state. In the target parking state, the preset state machine may determine parking information based on the shared signal set and a private signal set corresponding to the target parking state. The terminal controls vehicle state switching by using the preset state machine, updates, when switching to the target parking state, the private signal set corresponding to the target parking state based on the received sensor signal by using the preset state machine, and determines parking information of the target vehicle based on the current shared signal set and a current private signal set.

For example, in the target parking state, if a parking information generation condition is triggered, parking information of the target vehicle is determined based on the current shared signal set and the current private signal set, a parking lot of the target vehicle may be determined based on a GPS signal in the current shared signal set, a parking space of the target vehicle may be determined based on a vehicle rear-camera image in the current private signal set, and the parking lot and the parking space of the target vehicle are configured as the parking information of the target vehicle.

In an embodiment, the preset state machine includes a state set and a transfer function. The terminal establishes a base class including a shared variable, the shared variable corresponding to the shared signal set, and establishes various sensor input functions, the sensor input functions being functions for accepting a sensor signal input. Further, the terminal establishes sub-classes respectively corresponding to the vehicle states based on the base class, the sub-classes inheriting the base class, and the sub-classes including private variables needed by the vehicle states, and rewrites sensor input function sets respectively corresponding to the sub-classes. The sensor input function sets corresponding to the sub-classes include sensor input functions respectively corresponding to various sensor signals required in the vehicle states corresponding to the sub-classes. Different vehicle states may require different sensor signals, and data processing performed based on the sensor signals may alternatively be different. Therefore, the sensor input function sets need to be rewritten. Finally, the preset state machine is obtained based on the base class, the sub-classes, and the sensor input function sets respectively corresponding to the sub-classes. Specifically, a transfer function needed by the preset state machine is obtained based on the sensor input function sets respectively corresponding to the sub-classes. In the current vehicle state, data processing is performed based on the sensor input function sets corresponding to the sub-classes corresponding to the current vehicle state. For example, the sensor input function stipulates a condition to which sensor signals need to be recorded. In the current vehicle state, a next vehicle state is determined based on the sensor input function sets corresponding to the sub-classes corresponding to the current vehicle state. For example, the sensor input function set stipulates a condition to which the vehicle needs to switch to which vehicle state. When switching is performed from the current vehicle state to the next vehicle state, a sub-class corresponding to the next vehicle state is assigned to the base class, and various needed sensor modules are invoked by using the base class to acquire sensor signals, thereby performing data processing.

In an embodiment, the terminal is a target vehicle. A vehicle finding application is set on the target vehicle, the vehicle finding application is an application for vehicle finding, and a preset state machine is set in the vehicle finding application. When the target vehicle is running, if a user opens a vehicle finding application on the target vehicle, the target vehicle enters an initial state. The target vehicle inputs a sensor signal generated in real time by a vehicle sensor to the preset state machine, and the preset state machine controls vehicle state switching based on the sensor signal, and generates parking information in a target parking state. The target vehicle may display the generated parking information in the vehicle finding application.

Further, the parking information may alternatively be displayed on a vehicle owner terminal, so that the user views the parking information by using the vehicle owner terminal at any time. The vehicle owner terminal refers to a terminal used by a driving user of the target vehicle, for example, a mobile phone, a computer, or a smart watch used by the driving user. A vehicle finding application may alternatively be set on the vehicle owner terminal, and the vehicle owner terminal and the target vehicle are bound in advance. The target vehicle may transmit the generated parking information to an application server corresponding to the vehicle finding application. The application server transmits the parking information to the vehicle owner terminal corresponding to the target vehicle, and displays the parking information on the vehicle finding application of the vehicle owner terminal.

The vehicle finding application may refer to a vehicle finding client installed in a terminal, and a client refers to a program installed and running on the terminal. The vehicle finding application may alternatively be an installation-free vehicle finding application program. An installation-free application program is an application program that can be used without being downloaded and installed. This type of application program may alternatively be referred to as a mini program, and usually runs in a client as a sub-program. The vehicle finding application may alternatively refer to a web vehicle finding application program opened by using a browser, a web application program is a program accessed by using a browser, and the like.

In the foregoing vehicle data processing method, a sensor signal generated by the vehicle sensor of the target vehicle is inputted to the preset state machine, the preset state machine including a logical relationship among a plurality of vehicle states; a shared signal set is updated, in a current vehicle state of the target vehicle, based on a received sensor signal by using the preset state machine, a next vehicle state of the target vehicle is determined based on a current shared signal set, and the target vehicle is switched from the current vehicle state to the next vehicle state, the shared signal set including sensor signals shared by vehicle states; a private signal set corresponding to a target parking state is updated, when switching to the target parking state, based on the received sensor signal by using the preset state machine, and parking information of the target vehicle is determined based on the current shared signal set and a current private signal set, the parking information being configured as vehicle finding guidance information of the target vehicle. Accordingly, the preset state machine includes a logical relationship among a plurality of vehicle states, and can intelligently analyze sensor signals generated in real time by a vehicle to switch the vehicle states and determine parking information, thereby improving the efficiency of determining parking information. The preset state machine determines the next vehicle state of the target vehicle based on sensor signals shared by the vehicle states, switches from the current vehicle state to the next vehicle state, and in a process of switching to the target parking state, determines parking information of the target vehicle based on the sensor signals shared by the vehicle states and sensor signals private to the target parking state. Vehicle state switching can be flexibly performed and vehicle finding guidance information can be quickly and accurately determined by using the shared signal set and the private signal set corresponding to the target parking state, thereby effectively improving vehicle finding efficiency and ensuring vehicle finding accuracy.

In an embodiment, the updating a shared signal set based on the received sensor signal includes:

adding a received vehicle positioning signal to a vehicle positioning signal sequence in the shared signal set, and adding a received vehicle motion signal to a vehicle motion signal sequence in the shared signal set; adding a received vehicle front-camera image meeting a first preset condition to a vehicle camera image sequence in the shared signal set; and adding a plurality of received sensor signals meeting a second preset condition to a mixed signal sequence in the shared signal set.

The shared signal set includes the vehicle positioning signal sequence, the vehicle motion signal sequence, the vehicle camera image sequence, and the mixed signal sequence.

The vehicle positioning signal sequence includes sequentially arranged vehicle positioning signals. The vehicle positioning signal is a GPS signal of the vehicle. The vehicle positioning signals may be configured for determining a parking lot. Determining a parking lot with reference to indoor or outdoor operating conditions can improve the accuracy of determining the parking lot.

The vehicle motion signal sequence includes sequentially arranged vehicle motion signals. The vehicle motion signal includes at least one of a speed sensor signal and an inertial measurement unit (IMU) signal. The vehicle motion signal sequence may be configured for determining a parking floor. Determining a parking floor with reference to indoor or outdoor operating conditions can improve the accuracy of determining the parking floor.

The vehicle camera image sequence includes sequentially arranged vehicle camera images. The vehicle camera images include a vehicle front-camera image. The vehicle front-camera image may be configured for determining a parking video.

The mixed signal sequence includes sequentially arranged mixed signals. The mixed signals include a plurality of sensor signals. For example, the mixed signals include a vehicle positioning signal, a vehicle motion signal, and a vehicle camera image. The mixed signal sequence may be configured for determining whether the vehicle is in an indoor state or in an outdoor state.

The first preset condition is a condition preset for the vehicle camera images, and is configured for determining whether the received vehicle camera images are added to the vehicle camera image sequence. The first preset condition may be set according to specific requirements. For example, the received vehicle camera images are added to the vehicle camera image sequence at every preset duration.

The second preset condition is a condition preset for the mixed signals, and is configured for determining whether the received sensor signals belonging to the mixed signals are added to the mixed signal sequence. The second preset condition may be set according to specific requirements. For example, the received sensor signals belonging to the mixed signals are added to the mixed signal sequence at every preset driving distance.

"A plurality of" is at least two. The sequential arrangement may be arrangement according to signal acquisition time, or may be arrangement according to vehicle-miles of travel.

Specifically, if receiving a vehicle positioning signal, the preset state machine adds the vehicle positioning signal to the vehicle positioning signal sequence in the shared signal set. If receiving a vehicle motion signal, the preset state machine adds the received vehicle motion signal to the vehicle motion signal sequence in the shared signal set.

The preset state machine, if receiving a vehicle front-camera image, determines whether the vehicle front-camera image meets the first preset condition. If the first preset condition is met, the vehicle front-camera image is added to the vehicle camera image sequence in the shared signal set. If the first preset condition is not met, the vehicle front-camera image does not need to be added to the vehicle camera image sequence in the shared signal set. For example, the latest collected vehicle front-camera images may be added to the vehicle camera image sequence in the shared signal set at every first preset vehicle operation distance; and the latest collected vehicle front-camera images may be added to the vehicle camera image sequence in the shared signal set at every first preset running time.

The preset state machine, if receiving sensor signals belonging to the mixed signals, determines whether the sensor signals meet the second preset condition. If the second preset condition is met, the sensor signals are added to the mixed signal sequence in the shared signal set. If the second preset condition is not met, the sensor signals do not need to be added to the mixed signal sequence in the shared signal set. For example, the latest collected sensor signals belonging to the mixed signals may be added to the mixed signal sequence in the shared signal set at every second preset vehicle operation distance; and the latest collected sensor signals belonging to the mixed signals may be added to the mixed signal sequence in the shared signal set at every second preset running time.

In the foregoing embodiment, the adding a received vehicle positioning signal to a vehicle positioning signal sequence in the shared signal set, and adding a received vehicle motion signal to a vehicle motion signal sequence in the shared signal set can ensure that the vehicle positioning signal sequence and the vehicle motion signal sequence have sufficient data, and improve the accuracy of subsequent data processing. A received vehicle front-camera image meeting the first preset condition is added to the vehicle camera image sequence in the shared signal set. A data volume of the vehicle front-camera image is relatively large. Filtering the vehicle front-camera image based on the first preset condition can save computer storage resources. A plurality of received sensor signals meeting the second preset condition are added to the mixed signal sequence in the shared signal set. The mixed signals include a plurality of sensor signals and have a relatively large data volume. Filtering the mixed signals based on the second preset condition can save computer storage resources. In addition, the vehicle states include a state in which a vehicle is located indoors and a state in which a vehicle is located outdoors. The received related sensor signals are added to the shared signal set, so that the shared signal set may include a sensor signal outputted by the vehicle indoors and a sensor signal outputted by the vehicle outdoors. Such a shared signal set helps to improve the accuracy of determining a vehicle state, and helps to accurately distinguish the state in which the vehicle is located indoors from the state in which the vehicle is located outdoors.

In an embodiment, the adding a received vehicle front-camera image meeting a first preset condition to a vehicle camera image sequence in the shared signal set includes:

updating a accumulated vehicle mileage value of a first vehicle odometer in the shared signal set based on a received speed sensor signal; adding, when the accumulated vehicle mileage value of the first vehicle odometer is greater than a first preset threshold, a currently received vehicle front-camera image to the vehicle camera image sequence in the shared signal set, and resetting the accumulated vehicle mileage value of the first vehicle odometer; and deleting, when a quantity of images in the vehicle camera image sequence is greater than a second preset threshold, images from the vehicle camera image sequence in a forward order of image acquisition time.

The first vehicle odometer is a vehicle odometer for vehicle camera images. A vehicle odometer is configured to determine a driving distance of a vehicle. The vehicle camera images include a vehicle front-camera image. A vehicle front-camera image is an image obtained by shooting an environment in front of the vehicle. For example, the vehicle front-camera image is collected by a camera arranged on a vehicle head.

The speed sensor signal is a sensor signal reflecting a motion speed and a driving speed of the vehicle. For example, the speed sensor signal may be a wheel speed signal of the vehicle.

The first preset threshold and the second preset threshold may be set according to specific requirements.

Specifically, if the preset state machine receives the vehicle front-camera image, the vehicle front-camera image is added to the vehicle camera image sequence in the shared signal set when meeting the first preset condition. The first preset condition is related to the first vehicle odometer in the shared signal set. If receiving a speed sensor signal, the preset state machine updates a accumulated vehicle mileage value of the first vehicle odometer in the shared signal set based on a received speed sensor signal. The preset state machine may determine a vehicle speed based on the received speed sensor signal, determine a driving distance based on the vehicle speed and driving time, and update the accumulated vehicle mileage value of the first vehicle odometer based on the driving distance. The preset state machine compares, if receiving the vehicle front-camera image, the accumulated vehicle mileage value of the first vehicle odometer with the first preset threshold. When the accumulated vehicle mileage value of the first vehicle odometer is greater than the first preset threshold, the preset state machine adds the vehicle front-camera image to the vehicle camera image sequence in the shared signal set, and resets the accumulated vehicle mileage value of the first vehicle odometer. The accumulated vehicle mileage value of the first vehicle odometer may be reset to a preset value. For example, the accumulated vehicle mileage value of the first vehicle odometer is reset to zero.

Further, when a quantity of images in the vehicle camera image sequence is greater than the second preset threshold, images in the vehicle camera image sequence may be deleted in a forward order of image acquisition time. That is, when the quantity of images in the vehicle camera image sequence is greater than the second preset threshold, an image first added to the vehicle camera image sequence may be deleted.

Reference may alternatively be made to a process of generating the vehicle camera image sequence in the shared signal set for a process of generating the mixed signal sequence in the shared signal set, and different types of sensor signals belonging to the mixed signals may correspond to same or different receiving frequencies for being added to the mixed signal sequence.

In an embodiment, a second preset threshold corresponding to the indoor parking state is greater than a second preset threshold corresponding to another vehicle state. The vehicle camera image sequence is configured for generating a parking video. In the indoor parking state, more vehicle front-camera images are added to the vehicle camera image sequence in the shared signal set, so that a proportion of images shot indoors in the parking video can be improved, thereby ensuring the guidance accuracy of the parking video and improving vehicle finding accuracy.

In the foregoing embodiment, the adding, when the accumulated vehicle mileage value of the first vehicle odometer is greater than a first preset threshold, a currently received vehicle front-camera image to the vehicle camera image sequence in the shared signal set, and resetting the accumulated vehicle mileage value of the first vehicle odometer can add the vehicle front-camera image to the vehicle camera image sequence in the shared signal set at every preset vehicle operation distance by using the accumulated vehicle mileage value of the first vehicle odometer, thereby ensuring that guiding images can be stably held in the vehicle camera image sequence in the shared signal set. When a quantity of images in the vehicle camera image sequence is greater than a second preset threshold, images in the vehicle camera image sequence are deleted in a forward order of image acquisition time, so that images occupying computer resources and having little guidance effect can be deleted in time from the vehicle camera image sequence, thereby improving the effective utilization of storage space.

In an embodiment, the determining a next vehicle state of the target vehicle based on the current shared signal set includes:

inputting, when the current vehicle state of the target vehicle is not a stopping state and a sensor signal indicating a vehicle stop is not received, the mixed signal sequence in the current shared signal set to a parking lot access identification model to obtain a predicted vehicle state, and using the predicted vehicle state as a next vehicle state of the target vehicle, the predicted vehicle state being an indoor parking state or an outdoor state; determining, when the sensor signal indicating a vehicle stop is received, that the next vehicle state of the target vehicle is the stopping state; and determining, when a sensor signal indicating a vehicle start is received in the stopping state, that the next vehicle state of the target vehicle is a starting state.

The parking lot access identification model is an artificial intelligence model, and is configured to identify whether a vehicle enters an indoor parking lot or leaves an indoor parking lot. The input data of the parking lot access identification model is a mixed signal sequence, and the output data is the predicted vehicle state, the predicted vehicle state being an indoor parking state or an outdoor state. The predicted vehicle state being the indoor parking state indicates that it is identified that the vehicle enters an indoor parking lot, and the predicted vehicle state being the outdoor state indicates that it is identified that the vehicle leaves an indoor parking lot.

Specifically, the preset state machine determines, when receiving the sensor signal indicating a vehicle stop, that the next vehicle state of the target vehicle is the stopping state. That is, after the vehicle is started, if a vehicle stop is detected, the next vehicle state of the target vehicle is determined to be the stopping state, and then the vehicle is switched to the stopping state.

In the stopping state, the preset state machine determines, when receiving the sensor signal indicating a vehicle start, that the next vehicle state of the target vehicle is a starting state. That is, after the vehicle is stopped, if a vehicle start is detected, the next vehicle state of the target vehicle is determined to be the starting state, and then the vehicle is switched to the starting state. The starting state may alternatively be referred to as an initial state.

The preset state machine inputs, when the current vehicle state of the target vehicle is not the stopping state and the sensor signal indicating a vehicle stop is not received, the mixed signal sequence in the current shared signal set to the parking lot access identification model to obtain the predicted vehicle state, and uses the predicted vehicle state as the next vehicle state of the target vehicle. That is, after the vehicle is started, if it is identified that the vehicle enters an indoor parking lot, the next vehicle state of the target vehicle is determined to be the indoor parking state, and then the vehicle is switched to the indoor parking state.

The sensor signal indicating a vehicle stop may be a parking gear, for example, a P gear, or may be another sensor signal. The sensor signal indicating a vehicle start may be a forward gear, for example, an N gear, or may be another sensor signal.

In an embodiment, the parking lot access identification model is a multimodal model. The multimodal model is an artificial intelligence model that can process a plurality of types of data. The multimodal model can provide more comprehensive and accurate information with reference to different types of data. The latest mixed signal sequence may be input to the parking lot access identification model regularly. The parking lot access identification model can output an accurate predicted vehicle state with reference to a plurality of sensor signals in the mixed signal sequence.

In the foregoing embodiment, the mixed signal sequence in the current shared signal set includes a plurality of sensor signals, and the mixed signal sequence in the current shared signal set is input to the parking lot access identification model to obtain the predicted vehicle state, so that whether the vehicle enters an indoor parking lot or leaves an indoor parking lot can be accurately determined with reference to the sensor signals from multiple perspectives, thereby improving the determining accuracy.

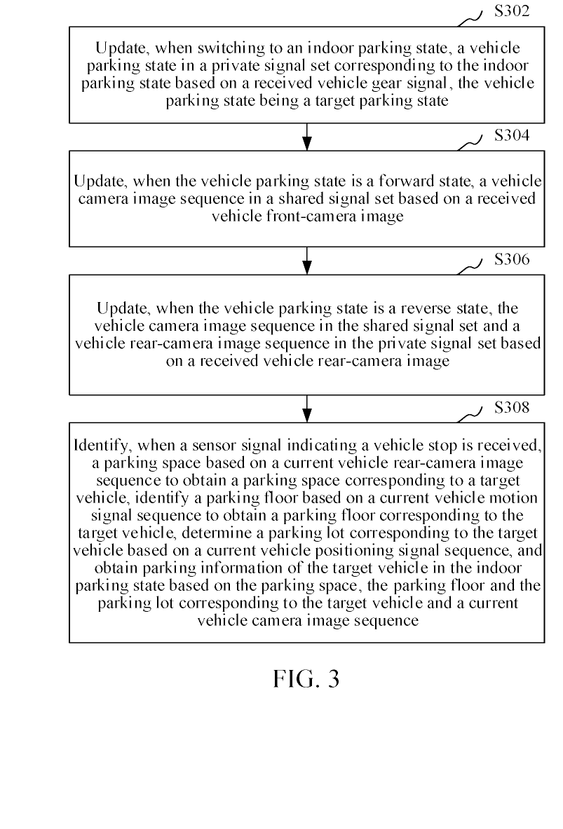

In an embodiment, as shown in FIG. 3, the updating, when switching to a target parking state, a private signal set corresponding to the target parking state based on the received sensor signal, and determining parking information of the target vehicle based on the current shared signal set and a current private signal set includes:

Operation S302: Update, when switching to the indoor parking state, a vehicle parking state in the private signal set corresponding to the indoor parking state based on a received vehicle gear signal, the indoor parking state being the target parking state.

The target parking state is the indoor parking state. The private signal set corresponding to the indoor parking state includes a vehicle parking state. The vehicle parking state is divided into a forward state and a reverse state. When a vehicle gear signal indicating a reverse gear is received, the vehicle parking state is determined to be the reverse state. When a vehicle gear signal indicating a forward gear is received, the vehicle parking state is determined to be the forward state.

Operation S304: Update, when the vehicle parking state is the forward state, the vehicle camera image sequence in the shared signal set based on the received vehicle front-camera image.

Operation S306: Update, when the vehicle parking state is the reverse state, the vehicle camera image sequence in the shared signal set and a vehicle rear-camera image sequence in the private signal set based on a received vehicle rear-camera image.

The private signal set corresponding to the indoor parking state further includes a vehicle rear-camera image sequence. The vehicle rear-camera image sequence includes sequentially arranged vehicle rear-camera images. A vehicle rear-camera image is an image obtained by shooting an environment behind the vehicle. For example, the vehicle rear-camera image is collected by a camera arranged on a vehicle tail. The vehicle rear-camera image may be configured for determining a parking space.

Specifically, when a vehicle is switched to the indoor parking state, if receiving a vehicle gear signal, the preset state machine updates the vehicle parking state in the private signal set corresponding to the indoor parking state in time based on the vehicle gear signal. When the vehicle parking state is the forward state, if receiving a vehicle front-camera image, the preset state machine updates the vehicle camera image sequence in the shared signal set based on the vehicle front-camera image to record a front driving image. When the vehicle parking state is the reverse state, if receiving a vehicle rear-camera image, the preset state machine updates the vehicle camera image sequence in the shared signal set based on the received vehicle rear-camera image to record a rear reverse image. When the vehicle parking state is the reverse state, if receiving a vehicle rear-camera image, the preset state machine may alternatively update the vehicle rear-camera image sequence in the private signal set based on the received vehicle rear-camera image.

Operation S308: Identify, when the sensor signal indicating a vehicle stop is received, a parking space based on a current vehicle rear-camera image sequence to obtain a parking space corresponding to the target vehicle, identify a parking floor based on a current vehicle motion signal sequence to obtain a parking floor corresponding to the target vehicle, determine a parking lot corresponding to the target vehicle based on a current vehicle positioning signal sequence, and obtain parking information of the target vehicle in the indoor parking state based on the parking space, the parking floor and the parking lot corresponding to the target vehicle and a current vehicle camera image sequence.

The vehicle rear-camera image sequence in the private signal set is configured for identifying a parking space, the parking space referring to a space for parking. For example, a parking space number is identified based on the vehicle rear-camera image in the vehicle rear-camera image sequence. The vehicle motion signal sequence in the shared signal set is configured for identifying a parking floor, and the parking floor refers to a vehicle parking floor. For example, a vehicle operation floor is identified as a parking floor based on a vehicle motion signal in the vehicle motion signal sequence. The vehicle positioning signal sequence in the shared signal set is configured for identifying a parking lot, and the parking lot refers to a vehicle parking building.

The current vehicle rear-camera image sequence is a latest vehicle rear-camera image sequence. The current vehicle motion signal sequence is a latest vehicle motion signal sequence. The current vehicle positioning signal sequence is a latest vehicle positioning signal sequence.

Specifically, the preset state machine, if receiving the sensor signal indicating a vehicle stop, identifies a parking space based on a current vehicle rear-camera image sequence to obtain a parking space corresponding to the target vehicle, identifies a parking floor based on a current vehicle motion signal sequence to obtain a parking floor corresponding to the target vehicle, determines a parking lot corresponding to the target vehicle based on a current vehicle positioning signal sequence, and obtains parking information of the target vehicle in the indoor parking state based on the parking space, the parking floor and the parking lot corresponding to the target vehicle and a current vehicle camera image sequence.

In the foregoing embodiment, when the vehicle is switched to the indoor parking state, a vehicle parking state in the private signal set corresponding to the indoor parking state is updated based on the received vehicle gear signal. Different data processing needs to be performed on different vehicle parking states, to subsequently generate accurate parking information. When the vehicle parking state is the forward state, the vehicle camera image sequence in the shared signal set is updated based on the received vehicle front-camera image to record a front driving image and generate a parking video including the front driving image. When the vehicle parking state is the reverse state, the vehicle camera image sequence in the shared signal set is updated based on the received vehicle rear-camera image to record a rear driving image and generate a parking video including the rear driving image, and the vehicle rear-camera image sequence in the private signal set is updated based on the received vehicle rear-camera image to identify a parking space. When the sensor signal indicating a vehicle stop is received, a parking space is identified based on the current vehicle rear-camera image sequence, a parking floor is identified based on the current vehicle motion signal sequence, a parking lot is identified based on the current vehicle positioning signal sequence, and comprehensive and accurate parking information of the target vehicle in the indoor parking state can be obtained based on the parking space, the parking floor and the parking lot corresponding to the target vehicle and the current vehicle camera image sequence.

In an embodiment, the updating the vehicle camera image sequence in the shared signal set and a vehicle rear-camera image sequence in the private signal set based on a received vehicle rear-camera image includes:

adding a received vehicle rear-camera image to the vehicle camera image sequence in the shared signal set; updating a accumulated vehicle mileage value of a second vehicle odometer in the private signal set based on a received speed sensor signal; and adding, when the accumulated vehicle mileage value of the second vehicle odometer is greater than a third preset threshold and a vacant parking space is available within a preset range of the target vehicle, a currently received vehicle rear-camera image to the vehicle rear-camera image sequence in the private signal set, and resetting the second vehicle odometer.

The second vehicle odometer is a vehicle odometer for vehicle rear-camera images. The third preset threshold and the preset range may be set according to specific requirements.

Specifically, in the indoor parking state, if receiving a speed sensor signal, the preset state machine updates the accumulated vehicle mileage value of the second vehicle odometer in the private signal set corresponding to the indoor parking state based on the speed sensor signal. In the indoor parking state, when the vehicle parking state is the reverse state, if receiving a vehicle rear-camera image, the preset state machine adds the vehicle rear-camera image to the vehicle camera image sequence in the shared signal set, and when the accumulated vehicle mileage value of the second vehicle odometer is greater than the third preset threshold and a vacant parking space is available within the preset range of the target vehicle, the preset state machine adds the currently received vehicle rear-camera image to the vehicle rear-camera image sequence in the private signal set, and resets the second vehicle odometer.

In an embodiment, whether a vacant parking space is available within the preset range of the target vehicle may be identified by using a parking space identification model. The parking space identification model is an artificial intelligence model. Input data of the parking space identification model is a vehicle surround-view camera image, and output data is a predicted label. The predicted label is divided into a positive label and a negative label. The positive label indicates that a vacant parking space is available within the preset range of the target vehicle, and the negative label indicates that no vacant parking space is available within the preset range of the target vehicle.

In the foregoing embodiment, a received vehicle rear-camera image is added to the vehicle camera image sequence in the shared signal set, to record a rear driving image in a reversing process and generate a parking video including the rear driving image. No vacant parking space available within the preset range of the target vehicle indicates that the target vehicle is still in a process of searching for a vacant parking space. In this case, the collected vehicle rear-camera image has little effect on determining a parking space. Therefore, when the accumulated vehicle mileage value of the second vehicle odometer is greater than the third preset threshold and a vacant parking space is available within the preset range of the target vehicle, adding a currently received vehicle rear-camera image to the vehicle rear-camera image sequence in the private signal set can avoid adding a useless vehicle rear-camera image to the vehicle rear-camera image sequence in the private signal set, thereby saving computer resources and improving the effective utilization of storage space.

In an embodiment, the vehicle data processing method further includes:

performing character recognition on the vehicle rear-camera image added to the vehicle rear-camera image sequence in the private signal set to obtain a parking space identifier corresponding to the vehicle rear-camera image and recognition confidence.

The identifying a parking space based on a current vehicle rear-camera image sequence to obtain a parking space corresponding to the target vehicle includes:

selecting vehicle rear-camera images having recognition confidence greater than preset confidence as candidate rear-camera images from the current vehicle rear-camera image sequence; computing parking space identifier similarity among the candidate rear-camera images based on parking space identifiers corresponding to the candidate rear-camera images; determining a target rear-camera image from the candidate rear-camera images based on the parking space identifier similarity; and determining a parking space corresponding to the target vehicle based on a parking space identifier corresponding to the target rear-camera image.

The character recognition refers to optical character recognition (OCR). Performing character recognition on the vehicle rear-camera image refers to performing OCR on the vehicle rear-camera image to recognize a parking space identifier in the vehicle rear-camera image. The parking space identifier is an identifier for identifying a parking space. For example, the parking space identifier may be a parking space number.

The recognition confidence is configured for representing recognition credibility and recognition accuracy of the parking space identifier. Higher recognition confidence indicates higher accuracy of a recognition result. The preset confidence is a preset confidence threshold, and is configured for screening a vehicle rear-camera image.

Parking space identifier similarity between two rear-camera images refers to similarity between parking space identifiers corresponding to the two rear-camera images.

Specifically, the preset state machine may perform OCR on the vehicle rear-camera image added to the vehicle rear-camera image sequence in the private signal set to obtain a parking space identifier corresponding to the vehicle rear-camera image and recognition confidence. OCR may be performed when the vehicle rear-camera image is added to the vehicle rear-camera image sequence, or OCR may be performed on the vehicle rear-camera image in the vehicle rear-camera image sequence when a parking space is identified.

When a parking space is identified, the preset state machine first screens vehicle rear-camera images based on preset confidence, and selects vehicle rear-camera images having recognition confidence greater than the preset confidence as candidate rear-camera images from the current vehicle rear-camera image sequence. Further, the preset state machine determines the target rear-camera image from the screened candidate rear-camera images, and determines a parking space corresponding to the target vehicle based on a parking space identifier corresponding to the target rear-camera image. For example, if the parking space identifier corresponding to the target rear-camera image is P17, P17 is configured as the parking space identifier of a parking space corresponding to the target vehicle. The preset state machine computes parking space identifier similarity among the candidate rear-camera images based on parking space identifiers corresponding to the candidate rear-camera images, and determines the target rear-camera image from the candidate rear-camera images based on the parking space identifier similarity. For example, a candidate rear-camera image having highest parking space identifier similarity to other candidate rear-camera images is configured as the target rear-camera image; and a candidate rear-camera image having parking space identifier similarity to other candidate rear-camera image greater than preset similarity is configured as the target rear-camera image.

In the foregoing embodiment, the selecting vehicle rear-camera images having recognition confidence greater than preset confidence as candidate rear-camera images from the current vehicle rear-camera image sequence can filter out a vehicle rear-camera image having inaccurate identification, thereby helping to improve the accuracy of identifying a parking space. The computing parking space identifier similarity among the candidate rear-camera images based on parking space identifiers corresponding to the candidate rear-camera images, and determining a target rear-camera image from the candidate rear-camera images based on the parking space identifier similarity can use a candidate rear-camera image including a complete parking space identifier as the target rear-camera image, where the candidate rear-camera image including a complete parking space identifier is a candidate rear-camera image that is relatively similar to other candidate rear-camera images; and the determining a parking space corresponding to the target vehicle can ensure the accuracy of identifying a parking space based on a parking space identifier corresponding to the target rear-camera image.

In an embodiment, the identifying a parking floor based on a current vehicle motion signal sequence to obtain a parking floor corresponding to the target vehicle includes:

determining a vehicle front driving angle sequence of the target vehicle based on an IMU signal in a current vehicle motion signal sequence, and determining a driving speed sequence of the target vehicle based on a speed sensor signal in the current vehicle motion signal sequence; and determining a parking floor corresponding to the target vehicle based on the vehicle front driving angle sequence and the driving speed sequence of the target vehicle.

The IMU signal is configured for determining a vehicle front driving angle. The speed sensor signal is configured for determining a vehicle speed, and determining a vehicle operation floor with reference to the vehicle front driving angle and the vehicle speed.

Specifically, when a parking floor is identified, the preset state machine determines a vehicle front driving angle sequence of the target vehicle based on an IMU signal in a current vehicle motion signal sequence, the vehicle front driving angle sequence including vehicle front driving angles arranged in an order of time. Whether the vehicle is driving downwards, upwards, or horizontally may be determined based on the vehicle front driving angle. The preset state machine determines a driving speed sequence of the target vehicle based on a speed sensor signal in the current vehicle motion signal sequence, the driving speed sequence including vehicle speeds arranged in an order of time. The distance traveled by a vehicle may be determined based on a vehicle speed. A travel distance of the vehicle in a direction perpendicular to the ground surface may be determined with reference to the vehicle front driving angle of the and the vehicle speed, to determine a parking floor. For example, if the vehicle first drives downwards and then horizontally, and the travel distance in the direction perpendicular to the ground surface when downward traveling exceeds a preset distance, the vehicle is determined to have run downwards one floor. The preset state machine determines a parking floor corresponding to the target vehicle based on the vehicle front driving angle sequence and the driving speed sequence of the target vehicle. When it is identified that the target vehicle enters an indoor parking lot, the target vehicle is determined to be on the ground surface, and a floor passed by the target vehicle is determined based on the vehicle front driving angle sequence and the driving speed sequence to determine a parking floor.

In the foregoing embodiment, the vehicle front driving angle sequence and the driving speed sequence of the target vehicle are determined based on the current vehicle motion signal sequence, the vehicle front driving angle sequence being configured for determining the moving direction of the vehicle in the direction perpendicular to the ground surface, and the driving speed sequence being configured for determining the driving distance of the vehicle. With reference to the vehicle front driving angle sequence and the driving speed sequence of the target vehicle, the moving direction of the vehicle in the direction perpendicular to the ground surface is determined, and then the parking floor corresponding to the target vehicle is determined. Determining the parking floor corresponding to the target vehicle with reference to the vehicle front driving angle sequence and the driving speed sequence of the target vehicle can ensure the accuracy of identifying a parking floor.

In an embodiment, the determining a parking lot corresponding to the target vehicle based on a current vehicle positioning signal sequence includes:

acquiring a vehicle positioning signal having signal strength greater than preset strength in a reverse order of signal generation time from the current vehicle positioning signal sequence as a target positioning signal; and using a point of interest corresponding to the target positioning signal as the parking lot corresponding to the target vehicle.

The vehicle positioning signal is a GPS signal, and the GPS signal has a corresponding signal strength. The preset strength is a signal strength threshold that is set in advance, and is configured for screening a GPS signal. A point of interest is POI for short. A POI corresponding to the target positioning signal is a POI closest to the target positioning signal.

Specifically, when a parking lot is identified, the preset state machine acquires a vehicle positioning signal having signal strength greater than the preset strength in a reverse order of signal generation time from a current vehicle positioning signal sequence as the target positioning signal, that is, to acquire a recently collected vehicle positioning signal having signal strength greater than the preset strength from the current vehicle positioning signal sequence as the target positioning signal. The preset state machine queries a corresponding POI based on the target positioning signal, and uses the POI corresponding to the target positioning signal as a parking lot corresponding to the target vehicle.

In the foregoing embodiment, after the vehicle enters an indoor parking lot, a collected GPS signal is relatively weak and inaccurate. When a parking lot is identified, a vehicle positioning signal having signal strength greater than the preset strength is acquired in a reverse order of signal generation time from the current vehicle positioning signal sequence as the target positioning signal, so that a relatively strong GPS signal collected near the indoor parking lot can be configured as the target positioning signal, and a POI corresponding to the target positioning signal is configured as a parking lot corresponding to the target vehicle, thereby ensuring the accuracy of identifying a parking lot.

In an embodiment, the vehicle data processing method further includes:

updating, when the vehicle parking state is updated from the forward state to the reverse state, a accumulated vehicle mileage value of a third vehicle odometer in the private signal set based on a received speed sensor signal, the third vehicle odometer being configured to collect statistics on a accumulated vehicle mileage value from a time when the target vehicle enters the indoor parking state to a time when the target vehicle stops reversing last time; clearing, when a difference between a current accumulated vehicle mileage value and a historical accumulated vehicle mileage value of the third vehicle odometer is greater than a fourth preset threshold, the vehicle rear-camera image sequence in the private signal set; and clearing, after the parking information of the target vehicle in the indoor parking state is determined, the vehicle positioning signal sequence and the vehicle camera image sequence in the current shared signal set and the vehicle rear-camera image sequence in the private signal set.

The third vehicle odometer is configured to collect statistics on a accumulated vehicle mileage value from a time when the target vehicle enters the indoor parking state to a time when the target vehicle stops reversing last time. The current accumulated vehicle mileage value of the third vehicle odometer is a latest accumulated vehicle mileage value of the third vehicle odometer, and is configured for representing a accumulated vehicle mileage value from a time when the target vehicle enters the indoor parking state to a time when the target vehicle stops reversing last time. The historical accumulated vehicle mileage value of the third vehicle odometer is a previous accumulated vehicle mileage value of the third vehicle odometer, and is configured for representing a accumulated vehicle mileage value from a time when the target vehicle enters the indoor parking state to a time when the target vehicle stops reversing the time before last time.

The fourth preset threshold may be set according to specific requirements.

Specifically, the preset state machine updates, when the vehicle parking state is updated from the forward state to the reverse state, the accumulated vehicle mileage value of the third vehicle odometer in the private signal set based on the received speed sensor signal. A difference between the current accumulated vehicle mileage value and the historical accumulated vehicle mileage value of the third vehicle odometer being greater than the fourth preset threshold indicates that a driving distance passed between two consecutive reversing events is relatively large, and can reflect, to some extent, that the vehicle selects a new parking space. In this case, the preset state machine may clear the vehicle rear-camera image sequence in the private signal set, to avoid identifying, when subsequent parking space identification is performed, a parking space that has been given up by the vehicle. The preset state machine may clear, after the parking information of the target vehicle in the indoor parking state is determined, the vehicle positioning signal sequence and the vehicle camera image sequence in the current shared signal set and the vehicle rear-camera image sequence in the private signal set in time to prepare data for next parking of the target vehicle.

In the foregoing embodiment, the clearing, when a difference between a current accumulated vehicle mileage value and a historical accumulated vehicle mileage value of the third vehicle odometer is greater than a fourth preset threshold, the vehicle rear-camera image sequence in the private signal set and the clearing, after the parking information of the target vehicle in the indoor parking state is determined, the vehicle positioning signal sequence and the vehicle camera image sequence in the current shared signal set and the vehicle rear-camera image sequence in the private signal set can avoid data obfuscation between two parking events, and improve the accuracy of parking information generated each time.

In an embodiment, the vehicle data processing method further includes:

determining, when the sensor signal indicating a vehicle stop is received, the parking lot corresponding to the target vehicle based on the vehicle positioning signal sequence in the current shared signal set by using the preset state machine in a case of switching to the outdoor state; acquiring a vehicle surround-view camera image; and obtaining parking information of the target vehicle in the outdoor state based on the parking lot corresponding to the target vehicle and the vehicle surround-view camera image.

The vehicle surround-view camera image is an image obtained by shooting an environment around the vehicle.

Specifically, after the target vehicle leaves an indoor parking lot, corresponding parking information may alternatively be generated as vehicle finding guidance information when the target vehicle is parked outdoors. The terminal determines, when the sensor signal indicating a vehicle stop is received in the outdoor state, a parking lot corresponding to the target vehicle based on the vehicle positioning signal sequence in the current shared signal set by using the preset state machine. For example, a vehicle positioning signal having signal strength greater than a preset strength is acquired in a reverse order of signal generation time from the current shared signal set as a target positioning signal, and a POI corresponding to the target positioning signal is configured as a parking lot corresponding to the target vehicle. The terminal obtains, when the sensor signal indicating a vehicle stop is received in the outdoor state, a vehicle surround-view camera image by using the preset state machine to record surroundings of the vehicle in the outdoor parking state. Finally, the terminal obtains the parking information of the target vehicle in the outdoor state by using the preset state machine based on the parking lot corresponding to the target vehicle and the vehicle surround-view camera image.

The parking information in the outdoor state may further include other information, for example, a parking space.

In the foregoing embodiment, the determining, when the sensor signal indicating a vehicle stop is received in the outdoor state, a parking lot corresponding to the target vehicle based on the vehicle positioning signal sequence in the current shared signal set and the acquiring a vehicle surround-view camera image can quickly obtain concise parking information of the target vehicle in the outdoor state based on the parking lot corresponding to the target vehicle and the vehicle surround-view camera image.

In an embodiment, the vehicle data processing method further includes:

clearing, after parking information of the target vehicle in the outdoor state is determined by using the preset state machine, the vehicle positioning signal sequence, the vehicle motion signal sequence, and the vehicle camera image sequence in the current shared signal set.

Specifically, the terminal clears, after the parking information of the target vehicle in the outdoor state is determined by using the preset state machine, the vehicle positioning signal sequence, the vehicle motion signal sequence, and the vehicle camera image sequence in the current shared signal set to prepare data for next parking of the target vehicle. In addition, clearing the vehicle positioning signal sequence, the vehicle motion signal sequence, and the vehicle camera image sequence in the current shared signal set in time can avoid data obfuscation between two parking events and improve the accuracy of parking information generated each time.

In an embodiment, the vehicle data processing method further includes:

clearing, when the next vehicle state is determined to be the indoor parking state or the outdoor state by using the preset state machine, the vehicle positioning signal sequence and the vehicle camera image sequence in the current shared signal set.

Specifically, the terminal clears, when the next vehicle state is determined to be the indoor parking state or the outdoor state by using the preset state machine, the vehicle positioning signal sequence and the vehicle camera image sequence in the current shared signal set to prepare data for next parking of the target vehicle. In addition, clearing the vehicle positioning signal sequence and the vehicle camera image sequence in the current shared signal set in time can avoid data obfuscation between two parking events and improve the accuracy of parking information generated each time. The terminal does not clear, when the next vehicle state is determined to be the indoor parking state or the outdoor state by using the preset state machine, the vehicle motion signal sequence, helping to correctly determine a parking floor when parking indoors.

In an embodiment, the vehicle data processing method further includes:

acquiring, when switching from the target parking state to a stopping state, the parking lot and parking start time corresponding to the target vehicle from the parking information corresponding to the target vehicle, and determining a parking fee surcharge reminder condition corresponding to the target vehicle based on the parking lot and the parking start time; and generating, when parking duration of the target vehicle meets the parking fee surcharge reminder condition, a parking fee reminder notification corresponding to the target vehicle, the parking fee reminder notification being configured for being displayed on at least one of the target vehicle and a vehicle owner terminal corresponding to the target vehicle.

The parking start time may be a time for entering the target parking state. For example, for the indoor parking state, the parking start time may be a time when it is identified that a vehicle enters a parking lot. The parking start time may alternatively be a time for entering the stopping state. For example, for the indoor parking state, the parking start time may be a time when it is identified that a vehicle enters the stopping state. The parking duration is a period of continuous parking with the parking start time as a starting point.

The parking fee surcharge reminder means that in a parking lot, when a vehicle is parked for a period exceeding the predetermined free duration or the parking duration corresponding to the prepaid parking fee, the vehicle owner will be notified through a reminder that an additional parking fee needs to be paid. Usually, a particular period of time for free parking is set in a parking lot, for example, 30 minutes or one hour, and an additional parking fee needs to be paid after the period of time expires. When a vehicle is parked for a period exceeding the free duration, a corresponding fee will be automatically computed, and the vehicle owner will be reminded to pay the corresponding fee.

The parking fee surcharge reminder condition is a condition that needs to be met to trigger a parking fee surcharge reminder, and may be specifically set according to specific requirements. For example, the parking fee surcharge reminder condition may be set to remind every 10 minutes; and the parking fee surcharge reminder condition may be set to remind every additional 10 yuan to be paid. The parking fee reminder notification is a message for notifying a user to pay a parking fee.

Specifically, the terminal acquires, when switching from the target parking state to a stopping state, the parking lot and parking start time corresponding to the target vehicle from the parking information corresponding to the target vehicle, and determines a parking fee surcharge reminder condition corresponding to the target vehicle based on the parking lot and the parking start time. Different parking lots have different charging standards. The terminal generates, when parking duration of the target vehicle meets the parking fee surcharge reminder condition, a parking fee reminder notification corresponding to the target vehicle, and presents the parking fee reminder notification to the user. The parking fee reminder notification may be displayed on the target vehicle, or may be displayed on a vehicle owner terminal corresponding to the target vehicle.

In the foregoing embodiment, the determining, when switching from the target parking state to a stopping state, a parking fee surcharge reminder condition corresponding to the target vehicle based on the parking lot and the parking start time, and the generating, when parking duration of the target vehicle meets the parking fee surcharge reminder condition, a parking fee reminder notification corresponding to the target vehicle can automatically remind a user of information related to a parking fee in time, thereby improving the interaction efficiency.

In a specific embodiment, in the method of this application, by using the preset state machine, information related to a current vehicle parking position can be automatically determined by using a vehicle sensor, recorded, and informed to a user, thereby greatly reducing time and energy costs in a vehicle finding process. The preset state machine is a deterministic finite automation (DFA).

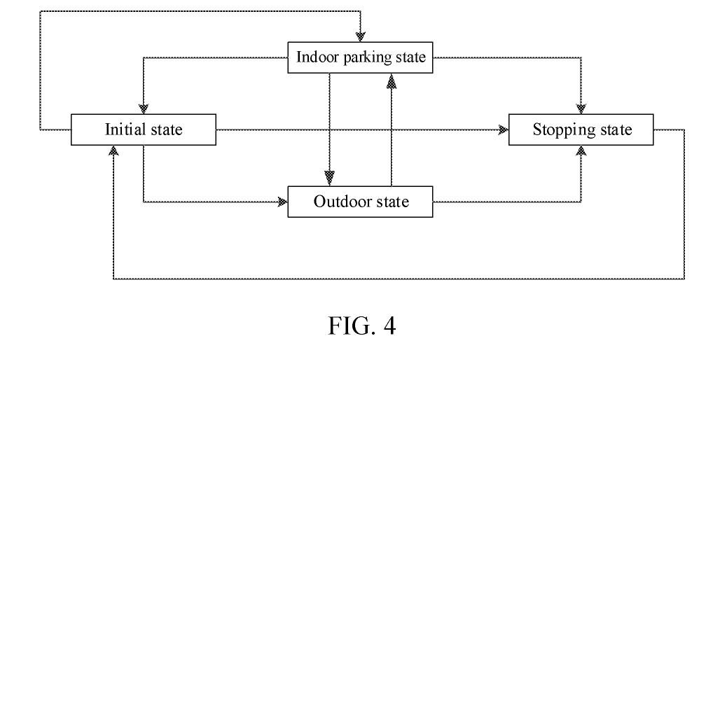

As shown in FIG. 4, the preset state machine includes four states: an initial state, an indoor parking state, an outdoor state, and a stopping state, which are respectively defined as follows: the initial state 1 is a state that is entered by default after a system is started; the indoor parking state 2 is a corresponding state when a vehicle is determined to be in an indoor parking lot by using an indoor parking lot access algorithm (i.e., a parking lot access identification model); the outdoor state 3 is a corresponding state when a vehicle is determined to be located outdoors by using the indoor parking lot access algorithm; and the stopping state 4 is a corresponding state when a sensor signal such as a P gear (having relatively low priority) flameout, or lock indicates that a vehicle is parked.

To implement functions such as recording a parking video, a parking space number, a parking position, a parking floor, and an automated message reminder in a parking process, a group of shared variables need to be maintained for each of the foregoing states. The shared variables include: a group of sensor sequences 1 that are arranged in sequence and have a fixed length, the sensor sequences 1 including data such as a camera image, a GPS signal, and a wheel speed, being configured as an input of the indoor parking lot access algorithm, and finally outputting a determining result of whether a vehicle is in an indoor parking lot; a group of sequentially arranged GPS position sequences 2; a group of sensor signal sequences 3 configured for computing a parking floor; a group of sequentially arranged image frame sequences 4; and a group of odometers (O1...On), configured to determine vehicle operation distances corresponding to different requirements. The sequentially arranged may be arranged in an order of time or odometer.

For each state, a private variable and a state transfer process thereof are:

I. Initial state 1

No private variable

State transfer:

1. Receive a front-camera image:

The odometer O2 is updated, and if a mileage L2 outputted by the odometer O2 is greater than a preset threshold, the front-camera image is added to the sequence 4. Then, O2 is reset. If a quantity of images in the sequence 4 is greater than a preset threshold T1, an image first added is kicked out.

When the sequence 1 meets the requirements of the indoor parking lot access algorithm, the sequence 1 is inputted into the indoor parking lot access algorithm. If the outputted result is outdoors, the sequence 4 is cleared, the sequence 2 is cleared, and the outdoor state 3 is switched. If the outputted result is indoors, the indoor parking state 2 is switched.

2. Receive a stopping signal such as a P gear/flameout:

The sequence 2 is cleared, the sequence 3 is cleared, the sequence 4 is cleared, and the stopping state 4 is switched.

3. Receive a GPS signal:

GPS data is added to the sequence 2.

4.Receive an IMU signal, a speedometer signal, and the like:

The sequence 3 is added.

II. Indoor parking state 2

Private variable: a mileage L1 from entering a parking lot to stopping reversing last time recorded by the odometer O1; a reverse state R, R being true if the vehicle is being reversed currently; and the sequence 5 of images shot by a rear-camera and configured for performing OCR and OCR results corresponding to the images.

State transfer:

1. Receive a front-camera image:

1-1. When the sequence 1 meets the requirements of the indoor parking lot access algorithm, the sequence 1 is inputted into the indoor parking lot access algorithm. If the outputted result is outdoors, the sequence 4 is cleared, the sequence 2 is cleared, and the outdoor state 3 is switched.

1-2. If R is false:

The odometer O2 is updated, and if a mileage L2 outputted by the odometer O2 is greater than a preset threshold, the front-camera image is added to the sequence 4, and then O2 is reset. If a quantity of images in the sequence 4 is greater than a preset threshold T2 (T2>T1), an image first added is kicked out.

2. Receive a GPS signal:

GPS data is added to the sequence 2.

3.Receive an IMU signal, a speedometer signal, and the like:

The sequence 3 is added.

4. Receive a reverse gear signal:

R is updated to true. If a difference between O1 and a previously recorded value is greater than a threshold, the sequence 5 is cleared, and a mileage corresponding to current O1 is recorded.

5. Receive a forward gear signal:

R is updated to false.

6. Receive a rear-camera image:

6-1. If R is true:

If a mileage L3 recorded by the odometer O3 is greater than a specified threshold, and a parking space identification model identifies that a parking space is available within a particular distance nearby, O3 is reset, the rear-camera image is added to the sequence 4, image preprocessing is performed on the rear-camera image to improve image quality, OCR is performed on the preprocessed image, and the preprocessed image is added to the sequence 5 along with parameters such as an identification result and confidence.

7. Receive a stopping signal such as a P gear/flameout:

R is updated to false. A parking floor is computed according to the sequence 3, then the sequence 3 is cleared, and O1 and O3 are reset.

A most appropriate parking space number and a picture corresponding to the parking space number are selected from the sequence 5, and a parking video is generated based on the sequence 4. A first GPS position having signal strength greater than a threshold is screened in a reverse order from the sequence 2, a POI is checked again, and a timestamp of entering a parking lot is determined according to GPS information. If necessary, a parking space identification result is matched with an indoor picture to obtain more accurate absolute positioning and floor information. Related information such as an image and a video are desensitized according to compliance requirements. Information such as a parking video, a parking space number, a parking space number image, a parking floor, and a parking position is uploaded to a background or user equipment, and a user is notified. If parking information cannot be provided due to no network or other reasons (for example, a number is not identified), a user is notified. Then, the sequence 2 is cleared, the sequence 4 is cleared, the sequence 5 is cleared, and the stopping state 4 is switched.

A parking fee surcharge reminder is set in the background according to the parking position or the entry time.

III. Outdoor state 3

No private variable

1. Receive a front-camera image:

The odometer O2 is updated, and if a mileage L2 outputted by the odometer O2 is greater than a preset threshold, the front-camera image is added to the sequence 4, and then O2 is reset. If a quantity of images in the sequence 4 is greater than a preset threshold T2 (T2>T1), an image first added is kicked out.

When the sequence 1 meets the requirements of the indoor parking lot access algorithm, the sequence 1 is inputted into the indoor parking lot access algorithm. If the outputted result is indoors, the indoor parking state 2 is switched.

2. Receive a stopping signal such as a P gear/flameout:

A first GPS position having signal strength greater than a threshold is screened in a reverse order from the sequence 2, and a POI is checked again. Four photographs of surroundings of the vehicle are captured by using a surround-view camera, a current time is recorded as a parking time, and related information such as a photograph is desensitized according to compliance requirements. The GPS and the photographs of the surroundings of the vehicle are uploaded to the background or user equipment, and a user is notified at the same time. If the uploading fails or the data acquisition fails, the user is notified. Then, the sequence 2 is cleared, the sequence 3 is cleared, the sequence 4 is cleared, and the stopping state 4 is switched.

A parking fee surcharge reminder is set in the background according to the parking position or the entry time.

3. Receive a GPS signal:

GPS data is added to the sequence 2.

4.Receive an IMU signal, a speedometer signal, and the like:

The sequence 3 is added.

IV. Stopping state 4:

No private variable

State transfer:

1. Receive a forward gear signal:

The initial state 1 is switched.

In one embodiment, the foregoing design may be conveniently implemented in an object-oriented mode. A specific mode is to establish a base class including a basic variable and functions for accepting various sensor inputs, and then a sub-class inherits the base class and establishes a private variable of the sub-class, to overwrite a sensor input function. During operation, state switching may be completed by dynamically binding switching instance at runtime.

The method of this application provides a deterministic finite automation (DFA) that has four states and can perform state transfer and a function operation only by relying on an in-vehicle sensor. This state machine can process a complex problem space composed of an infinite plurality of driving behaviors of a driver. The sensor relied on in the method of this application is hardware commonly equipped in a vehicle, which neither increases field end costs, nor requires a driver to spend extra energy on operation, thereby effectively reducing time and energy costs for the driver to find a vehicle in a parking lot.

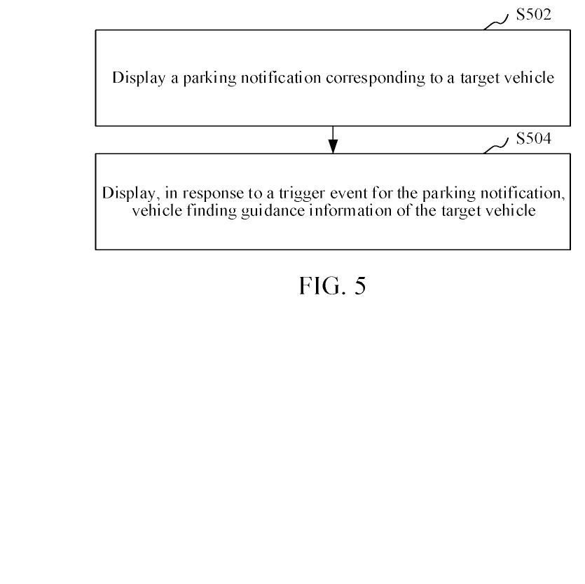

In an embodiment, as shown in FIG. 5, a vehicle data processing method is provided. With a case that the method is applied to a terminal as an example, description is provided. The terminal may be a target vehicle, or may be another terminal. Where:

Operation S502: Display a parking notification corresponding to a target vehicle.

The parking notification is a message notifying a user to view parking information.

Specifically, after parking information of the target vehicle is generated, the terminal may obtain a parking notification related to the parking information corresponding to the target vehicle, and the terminal displays the parking notification corresponding to the target vehicle for the user to view.

If the terminal is the target vehicle, the target vehicle may generate, after generating the parking information by using a preset state machine, a parking notification corresponding to the parking information, and display the parking notification corresponding to the target vehicle. If the terminal is a vehicle owner terminal of the target vehicle, the vehicle owner terminal may receive parking information transmitted from a server, generate a parking notification corresponding to the parking information, and display the parking notification corresponding to the target vehicle. If the terminal is a vehicle owner terminal of the target vehicle, the vehicle owner terminal may receive a parking notification transmitted from a server, and display the parking notification corresponding to the target vehicle.

The parking notification may be a message formed by using at least one type of media data such as a voice, a text, an image, and a video. Certainly, a presentation form of the parking notification may alternatively be set as required. For example, the parking notification may be a short message service (SMS) message, and a user is notified by using the SMS message to view parking information. The parking notification may be a reminder message of an application program, and the user is notified by using the reminder message of the application program to view the parking information in the application program. The reminder message of the application program may be displayed inside the application program, or may be displayed outside the application program, and the like.

Operation S504: Display, in response to a trigger event for the parking notification, vehicle finding guidance information of the target vehicle.

The trigger event for the parking notification may be generated based on a trigger operation of a user. For example, the user clicks the parking notification to generate the trigger event for the parking notification. The trigger event for the parking notification may alternatively be automatically triggered by meeting a condition. For example, if the user does not view the parking notification within a given time, the trigger event for the parking notification is automatically generated.

The vehicle finding guidance information is determined when switching to a target parking state, by updating a shared signal set and a private signal set corresponding to the target parking state based on a received sensor signal by using a preset state machine that controls vehicle state switching, and based on a current shared signal set and a current private signal set. The preset state machine includes a logical relationship among a plurality of vehicle states, and the shared signal set includes sensor signals shared by the vehicle states.

Reference may be made to content of the foregoing embodiments for a specific process of determining the vehicle finding guidance information, and details are not described herein again.

Specifically, the terminal displays, in response to the trigger event for the parking notification, vehicle finding guidance information of the target vehicle. The user can quickly learn related parking information of the target vehicle by viewing the vehicle finding guidance information.

For example, the parking notification corresponding to the target vehicle is displayed in a vehicle finding application, and after the user clicks the parking notification, the vehicle finding guidance information is further displayed in the vehicle finding application.

In an embodiment, the terminal displays, in response to the trigger event for the parking notification, a vehicle finding guidance interface, and displays the vehicle finding guidance information of the target vehicle in the vehicle finding guidance interface. The vehicle finding guidance interface is a user interface designed to help a user quickly find a vehicle parked by the user. The vehicle finding guidance interface is specifically configured to display the vehicle finding guidance information.

In the foregoing vehicle data processing method, the preset state machine includes a logical relationship among a plurality of vehicle states, and can intelligently analyze sensor signals generated in real time by a vehicle to switch the vehicle states and determine parking information, thereby improving the efficiency of determining parking information. The preset state machine determines the next vehicle state of the target vehicle based on sensor signals shared by the vehicle states, switches from the current vehicle state to the next vehicle state, and in a process of switching to the target parking state, determines parking information of the target vehicle based on the sensor signals shared by the vehicle states and sensor signals private to the target parking state. Vehicle state switching can be flexibly performed and vehicle finding guidance information can be quickly and accurately determined by using the shared signal set and the private signal set corresponding to the target parking state, thereby effectively improving vehicle finding efficiency and ensuring vehicle finding accuracy. The parking notification corresponding to the target vehicle is displayed, and the vehicle finding guidance information of the target vehicle is displayed in response to the trigger event for the parking notification, where the displayed vehicle finding guidance information may promptly help a user find a vehicle quickly.

In an embodiment, the displaying a parking notification corresponding to a target vehicle includes:

displaying, when the target vehicle is switched from the target parking state to a stopping state, a parking notification corresponding to the target vehicle in a parent application.

The displaying, in response to a trigger event for the parking notification, vehicle finding guidance information of the target vehicle includes:

entering, in response to a trigger operation on the parking notification, a vehicle finding child application in the parent application, and displaying vehicle finding guidance information of the target vehicle in the vehicle finding child application.

The parent application refers to an application program that can run independently. The child application refers to an application program that cannot be independently run without the parent application. For example, the child application may be a mini program. The vehicle finding child application is a child application for vehicle finding.

The trigger operation may be specifically a touch operation, a cursor operation, a key operation, or a voice operation. The touch operation may be a touch clicking operation, a touch pressing operation, or a touch sliding operation, and the touch operation may be a single-point touch operation or a multi-point touch operation. The cursor operation may be an operation of controlling a cursor to perform clicking or an operation of controlling a cursor to perform pressing. The key operation may be a virtual key operation, a physical key operation, or the like.

Specifically, the terminal acquires, when the target vehicle is switched from the target parking state to a stopping state, a parking notification corresponding to the target vehicle, and displays the parking notification corresponding to the target vehicle in the parent application. The user may enter the vehicle finding child application in the parent application by clicking the parking notification. The terminal enters, in response to the trigger operation on the parking notification, the vehicle finding child application in the parent application, and displays a parking notification corresponding to the target vehicle in the vehicle finding child application.

In an embodiment, the parking notification corresponding to the target vehicle is displayed on a vehicle finding platform of the parent application. The vehicle finding platform is a platform for releasing vehicle finding guidance information in the parent application. For example, the vehicle finding platform may be a vehicle finding official account in the parent application. The user may enter the vehicle finding child application in the parent application by clicking the parking notification. The terminal enters, in response to the trigger operation on the parking notification, the vehicle finding child application in the parent application, and displays a parking notification corresponding to the target vehicle in the vehicle finding child application.

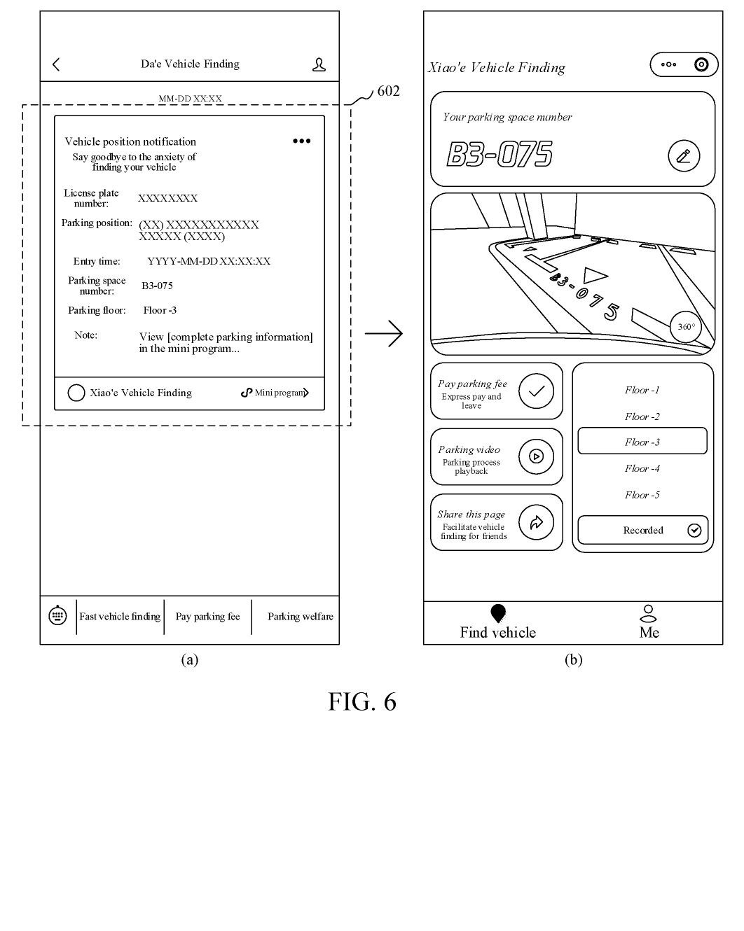

For example, referring to (a) in FIG. 6, a parking notification 602 corresponding to the target vehicle is displayed in a vehicle finding official account (e.g., Da'e Vehicle Finding) in the parent application. The parking notification 602 includes a license plate number, a parking position (i.e., a parking lot), an entry time (i.e., a parking start time), a parking space number (i.e., a parking space), and a parking floor number (i.e., a parking floor) corresponding to the target vehicle. The user may enter a vehicle finding child application (e.g., Xiao'e Vehicle Finding) in the parent application by clicking the parking notification. Referring to (b) in FIG. 6, vehicle finding guidance information of the target vehicle is displayed in the vehicle finding child application.

In the foregoing embodiment, the parking notification corresponding to the target vehicle is displayed in the parent application, the vehicle finding child application in the parent application is entered in response to a trigger operation on the parking notification, and the vehicle finding guidance information of the target vehicle is displayed in the vehicle finding child application. Through the interaction between the parent application and the child application, the parking notification and the vehicle finding guidance information that corresponds to the target vehicle may be conveniently displayed, thereby improving the vehicle finding efficiency.

In an embodiment, the displaying vehicle finding guidance information of the target vehicle includes:

displaying, in a parking space guidance area in the vehicle finding guidance interface, parking space information in the vehicle finding guidance information of the target vehicle, the parking space information including at least one of a parking space identifier and a parking space image corresponding to the target vehicle; displaying, in a parking lot guidance area in the vehicle finding guidance interface, parking lot information in the vehicle finding guidance information of the target vehicle, the parking lot information including at least one of a parking lot and a parking floor corresponding to the target vehicle; and displaying a vehicle finding control set in an operation function area in the vehicle finding guidance interface, the vehicle finding control set including at least one of a video playback control configured for playing a parking video in the vehicle finding guidance information of the target vehicle, a parking fee payment control configured for paying a parking fee, and a parking sharing control configured for sharing the vehicle finding guidance information of the target vehicle.

The vehicle finding guidance interface is an interface configured to display the vehicle finding guidance information. The vehicle finding guidance interface includes a parking space guidance area, a parking lot guidance area, and an operation function area. The parking space guidance area is configured to display parking space information, and the parking space information includes at least one of a parking space identifier and a parking space image corresponding to the target vehicle. The parking lot guidance area is configured to display parking lot information, and the parking lot information includes at least one of a parking lot and a parking floor corresponding to the target vehicle. The operation function area refers to a function area that can be operated by a user. The operation function area is configured to display a vehicle finding control set. The vehicle finding control set includes at least one control related to vehicle finding. The user may apply and use a related function by triggering the control.

Specifically, the vehicle finding guidance interface includes a parking space guidance area, a parking lot guidance area, and an operation function area. The terminal may display, in a parking space guidance area in the vehicle finding guidance interface, parking space information in the vehicle finding guidance information of the target vehicle, display, in a parking lot guidance area in the vehicle finding guidance interface, parking lot information in the vehicle finding guidance information of the target vehicle, and display, in an operation function area of the vehicle finding guidance interface, a vehicle finding control set.

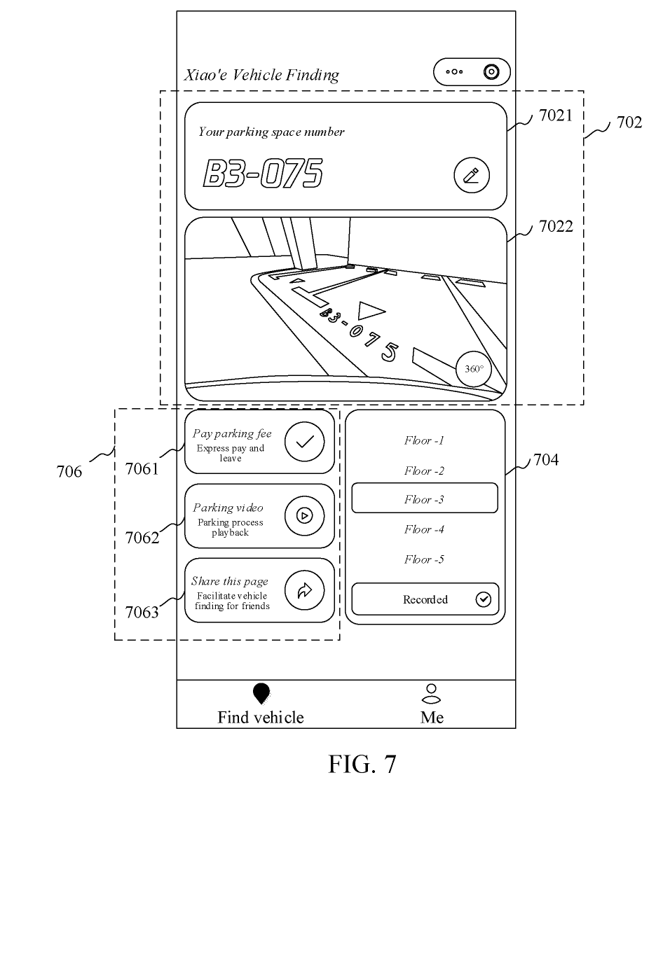

For example, referring to FIG. 7, 702 in FIG. 7 is a parking space guidance area, and a parking space identifier 7021 and a parking space image 7022 are displayed in the parking space guidance area. 704 in FIG. 7 is a parking lot guidance area, and a parking floor 704 is displayed in the parking lot guidance area. 706 in FIG. 7 is an operation function area, a parking fee payment control 7061 is displayed in the operation function area, and a user may click the parking fee payment control to pay a parking fee. A video playback control 7062 is displayed in the operation function area, and the user may click the video playback control to view a parking video. A parking sharing control 7063 is displayed in the operation function area, and the user may click the parking sharing control to share the vehicle finding guidance interface in which the parking guidance information of the target vehicle is displayed with another user.

In an embodiment, the parking space guidance area and the parking lot guidance area are editable areas. The user may edit and modify related parking information in the parking space guidance area. For example, for the parking space identifier displayed in the parking space guidance area, the user may modify the parking space identifier to modify an incorrectly identified parking space identifier to a correct parking space identifier. Referring to FIG. 7, if a parking space identifier (B3-075) displayed in the parking space guidance area is incorrect, the user may modify the parking space identifier by using an edit control displayed in the parking space guidance area, and modify an incorrect parking space identifier to a correct parking space identifier. Referring to FIG. 7, if a parking floor (floor -3) displayed in the parking lot guidance area is incorrect, the user may switch a parking floor by sliding or clicking the parking floor to modify an incorrect parking floor to a correct parking floor.

In the foregoing embodiment, different types of parking information are displayed in different areas of the vehicle finding guidance interface, so that the efficiency of viewing the parking information by the user can be improved, thereby helping improve the vehicle finding efficiency. The vehicle finding control set is displayed in the vehicle finding guidance interface, so that different vehicle finding functions can be implemented by using different types of vehicle finding controls, thereby helping improve the vehicle finding efficiency.

In an embodiment, the displaying vehicle finding guidance information of the target vehicle includes:

displaying a video playback control; playing, in response to a trigger operation on the video playback control, a parking video formed based on a vehicle camera image sequence in the vehicle finding guidance information of the target vehicle; highlighting a playback area of the parking video when the parking video is played; displaying a video turn-off control when the parking video is played; and canceling, in response to a trigger operation on the video turn-off control, playing of the parking video.

The video playback control is a control configured for starting playing a parking video. The video turn-off control is a control configured for turning off a parking video.

The highlighting may be highlighting selected content by marking in different colors or styles, so that the selected content is visually distinguished from other content to highlight the importance of the selected content.

Specifically, the vehicle finding guidance information of the target vehicle further includes a vehicle camera image sequence configured for generating a parking video, and the user may trigger playing of a parking video for vehicle finding. The terminal displays, in response to a trigger event for a parking notification, the video playback control, and the user may trigger the video playback control to start playing a parking video. The terminal plays, in response to a trigger operation on the video playback control, a parking video formed based on a vehicle camera image sequence in the vehicle finding guidance information of the target vehicle. When a parking video is played, the terminal may further display the video turn-off control, and the user may trigger the video turn-off control to turn off the parking video. The terminal cancels, in response to a trigger operation on the video turn-off control, playing of the parking video.

Further, the terminal may highlight a playback area of the parking video when the parking video is played.

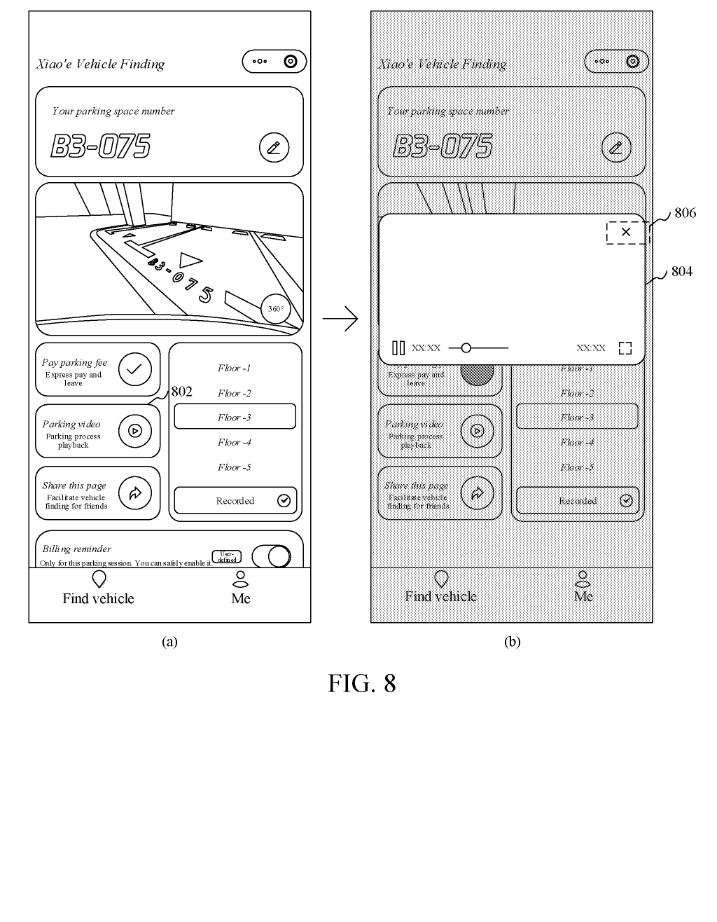

The terminal may display the video playback control in the vehicle finding guidance interface. For example, referring to (a) in FIG. 8, a video playback control 802 is displayed in the vehicle finding guidance interface, and the user clicks the video playback control to trigger playing of a parking video. Referring to (b) in FIG. 8, after the user clicks the video playback control, a playback area 804 is displayed on an upper layer of the vehicle finding guidance interface, and the parking video is played in the playback area. When the parking video is played, a playback area of the parking video is highlighted, and a lower layer of the vehicle finding guidance interface is darkened. A video turn-off control 806 is displayed in the playback area, and the user clicks the video turn-off control to turn off the parking video and close the playback area. Certainly, the terminal may alternatively display the video playback control in another interface. For example, the video playback control is displayed in an interface configured to display a parking notification.

In an embodiment, a video playback control is displayed in the vehicle finding guidance interface. When a parking video is played, the other areas in the vehicle finding guidance interface is in an operation-prohibited state, avoiding a mis-operation of the user when watching the parking video. After playing of the parking video is completed or the user triggers the video turn-off control, the other areas in the vehicle finding guidance interface is restored to an operation-permitted state.

In the foregoing embodiment, the user may trigger the video playback control to start playing a parking video, and may intuitively learn a parking position by playing the parking video, thereby further improving the vehicle finding efficiency.

In an embodiment, the vehicle data processing method further includes:

displaying a parking fee payment control; displaying, in response to a trigger operation on the parking fee payment control, a payment graphic code corresponding to the parking lot in the vehicle finding guidance information of the target vehicle; and transferring, in response to a trigger operation on the payment graphic code, a parking fee corresponding to the target vehicle to a parking fee account corresponding to the parking lot in the vehicle finding guidance information of the target vehicle.

The parking fee payment control is a control configured for paying a parking fee. The payment graphic code is a graphic code for payment. For example, the payment graphic code may be a payment quick response (QR) code. The vehicle finding guidance information includes a parking lot, and a parking lot has a corresponding parking fee account. A parking fee account corresponding to a parking lot is an account that is held in the parking lot and configured for collecting parking fees.

Specifically, the terminal may display the parking fee payment control, and the user may trigger the parking fee payment control to pay a parking fee. The terminal displays, in response to a trigger operation on the parking fee payment control, a payment graphic code corresponding to the parking lot in the vehicle finding guidance information of the target vehicle, and the user may trigger the payment graphic code to pay a parking fee. The terminal may query a parking lot of the target vehicle from the vehicle finding guidance information of the target vehicle, and then query a payment graphic code corresponding to the parking lot from the background. The terminal transfers, in response to a trigger operation on the payment graphic code, a parking fee corresponding to the target vehicle to a parking fee account corresponding to the parking lot in the vehicle finding guidance information of the target vehicle.

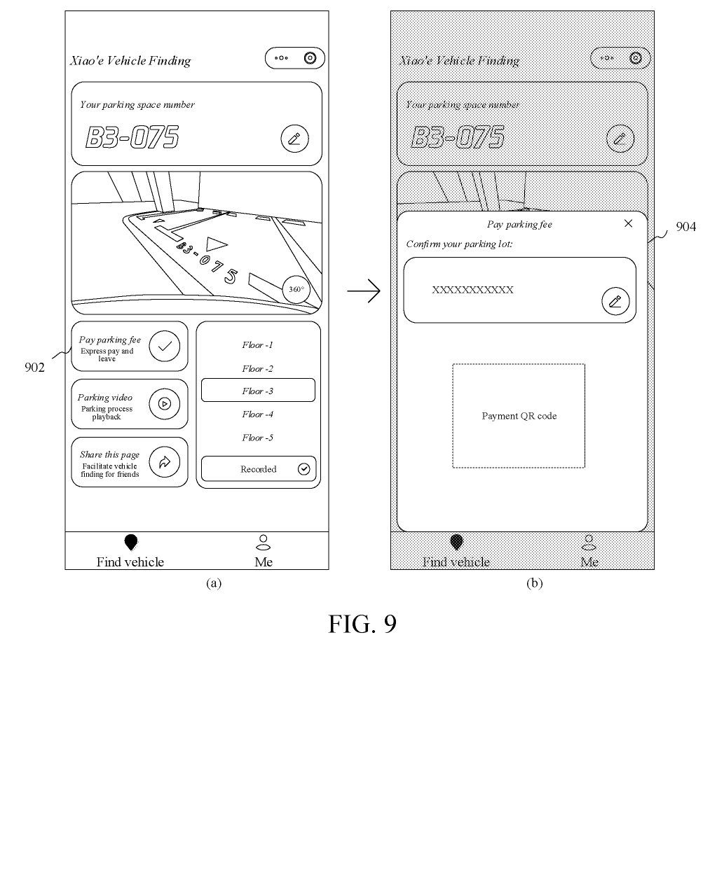

The terminal may display the parking fee payment control in the vehicle finding guidance interface. For example, referring to (a) in FIG. 9, a parking fee payment control 902 is displayed in the vehicle finding guidance interface, and the user clicks the parking fee payment control to trigger display of a payment graphic code. Referring to (b) in FIG. 9, after the user clicks the parking fee payment control, a payment area 904 is displayed on an upper layer of the vehicle finding guidance interface, a parking lot in the vehicle finding guidance information of the target vehicle is displayed in the payment area, and a payment graphic code corresponding to the parking lot is displayed in the payment area. The user may determine whether a displayed parking lot is correct. If the displayed parking lot is incorrect, the user may perform an editing operation to correct the parking lot. The user may transfer a parking fee corresponding to the target vehicle to the parking fee account corresponding to the parking lot by recognizing the payment graphic code. When the payment area is displayed, the payment area is highlighted, and a lower layer of the vehicle finding guidance interface is darkened.

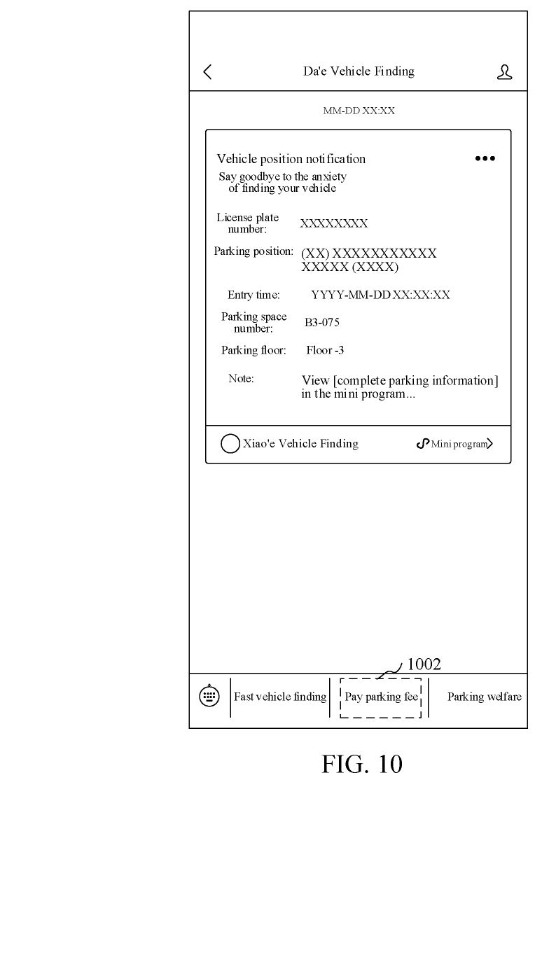

The terminal may alternatively display the parking fee payment control in another interface. For example, referring to FIG. 10, a parking fee payment control 1002 is displayed in a vehicle finding official account, and the user clicks the parking fee payment control to trigger display of a payment graphic code. The user may transfer a parking fee corresponding to the target vehicle to the parking fee account corresponding to the parking lot in the vehicle finding guidance information of the target vehicle by identifying the payment graphic code.

In the foregoing embodiment, the user may conveniently pay a parking fee by triggering the parking fee payment control. In a conventional technology, usually, the user searches for a payment graphic code in a parking lot, and then pays a parking fee by scanning the payment graphic code. However, in this application, a parking fee payment function and a vehicle finding guidance function are integrated, so that the user can not only find a vehicle quickly by viewing the vehicle finding guidance information, but also pay a parking fee quickly to a parking lot in the vehicle finding guidance information by using the parking fee payment control, thereby effectively improving the interaction convenience in a parking scenario.

In an embodiment, the vehicle data processing method further includes:

displaying a parking fee surcharge setting entrance; displaying, in response to a trigger operation on the parking fee surcharge setting entrance, a parking fee surcharge reminder attribute; and updating and displaying, in response to an editing operation on the parking fee surcharge reminder attribute, the parking fee surcharge reminder attribute as a parking fee surcharge reminder attribute edited through the editing operation, so that the parking fee surcharge reminder condition of the target vehicle is updated to an edited parking fee surcharge reminder attribute.

The parking fee surcharge setting entrance is an entrance for setting a parking fee surcharge reminder condition. The parking fee surcharge reminder condition includes at least one parking fee surcharge reminder attribute. The parking fee surcharge reminder attribute includes reminder factors such as a reminder period, a reminder time, and a reminder quantity of parking fee surcharge.

Specifically, the user may trigger the parking fee surcharge setting entrance to set a parking fee surcharge reminder condition. The terminal displays the parking fee surcharge setting entrance, and the user may trigger the parking fee surcharge setting entrance to display a parking fee surcharge reminder attribute. The parking fee surcharge reminder attribute is a component of the parking fee surcharge reminder condition. The terminal displays, in response to a trigger operation on the parking fee surcharge setting entrance, the parking fee surcharge reminder attribute, and the user may modify the parking fee surcharge reminder attribute to set a required parking fee surcharge reminder condition. For example, the user may input the required parking fee surcharge reminder attribute by using an input box, and the user may select the required parking fee surcharge reminder attribute by using an option box. The terminal updates and displays, in response to an editing operation on the parking fee surcharge reminder attribute, the parking fee surcharge reminder attribute as a parking fee surcharge reminder attribute edited through the editing operation, so that the parking fee surcharge reminder condition of the target vehicle is updated to an edited parking fee surcharge reminder attribute.

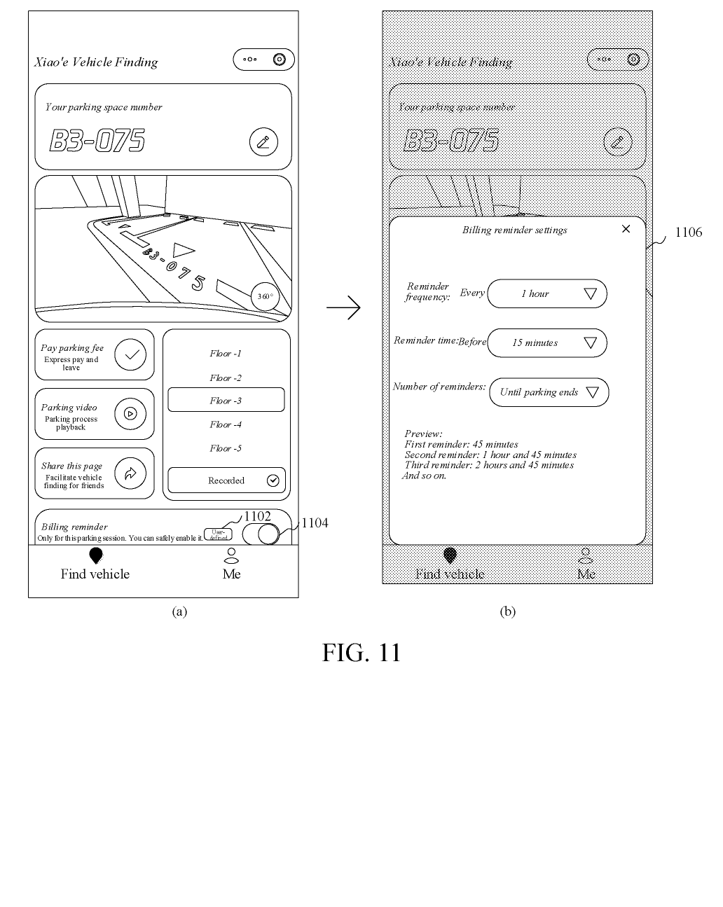

The terminal may display a parking fee surcharge setting entrance in the vehicle finding guidance interface. For example, referring to (a) in FIG. 11, a parking fee surcharge setting entrance 1102 and a parking fee surcharge reminder enabling control 1104 are displayed in the vehicle finding guidance interface. The user may click the parking fee surcharge reminder enabling control to enable or disable a parking fee surcharge reminder function, and the user may click the parking fee surcharge setting entrance to trigger display of a parking fee surcharge reminder attribute. Referring to (b) in FIG. 11, after the user clicks the parking fee surcharge setting entrance, a setting area 1106 is displayed in an upper layer of the vehicle finding guidance interface, and a parking fee surcharge reminder attribute is displayed in the setting area. The user may select a specific attribute value of the parking fee surcharge reminder attribute from a drop-down option box as required. A parking fee surcharge reminder condition is composed of attribute values selected by the user. When the parking fee surcharge reminder condition is met, a parking fee reminder notification is generated and displayed. Certainly, the terminal may alternatively present the parking fee surcharge setting entrance in another interface, for example, display the parking fee surcharge setting entrance in an interface configured to display a parking notification.

In the foregoing embodiment, in this application, the parking fee surcharge reminder condition may be a personalized condition. The parking fee surcharge reminder condition supports user setting, and the user may conveniently set the parking fee surcharge reminder condition by triggering the parking fee surcharge setting entrance. In addition, a parking fee surcharge reminder function and a vehicle finding guidance function are integrated, so that the user can not only find a vehicle quickly by viewing the vehicle finding guidance information, but also set the parking fee surcharge reminder condition by using the parking fee surcharge setting entrance, thereby effectively improving the interaction convenience in a parking scenario.

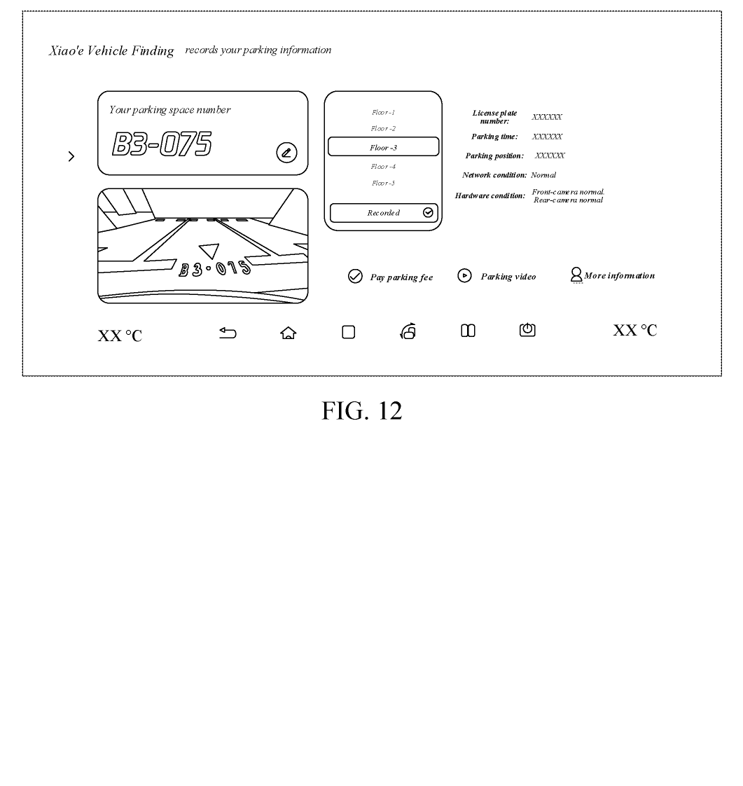

In a specific embodiment, the method of this application may be applied to intelligent vehicle finding at a vehicle terminal. The vehicle terminal refers to a terminal in which a vehicle is located. A vehicle finding application is downloaded from the target vehicle, the vehicle finding application is opened when the target vehicle is running. The vehicle finding application controls, by using a preset state machine, switching of a vehicle state, generates parking information in a target parking state by using the preset state machine, and displays, in the vehicle finding application, the generated parking information as vehicle finding guidance information. For a vehicle finding guidance interface of the vehicle terminal, refer to FIG. 12. The vehicle terminal displays parking space information, parking lot information, and a vehicle finding control set in the vehicle finding guidance interface. The parking space information includes a parking space identifier and a parking space image that correspond to the target vehicle, the parking lot information includes a parking lot and a parking floor that correspond to the target vehicle, and the vehicle finding control set includes a video playback control configured for playing a parking video in the vehicle finding guidance information and a parking fee payment control configured for paying a parking fee.

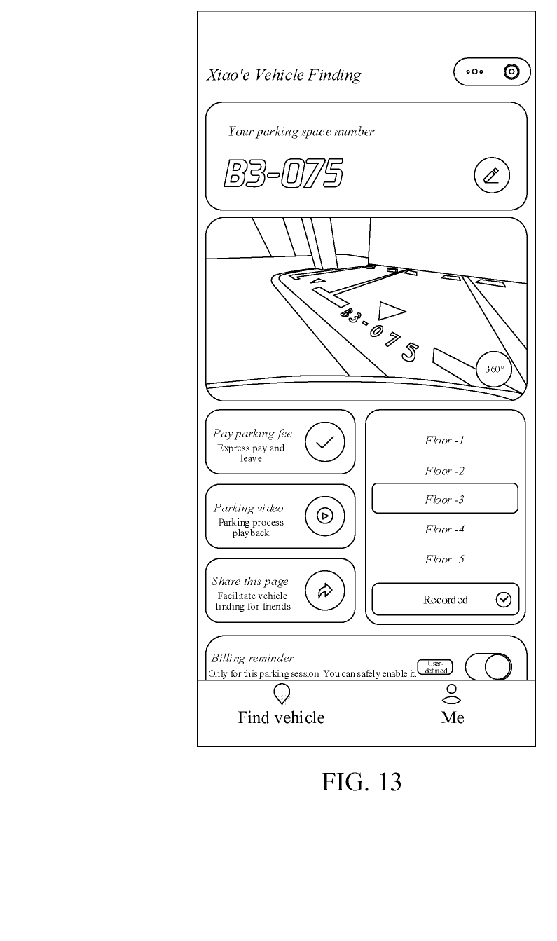

In a specific embodiment, the method of this application may be applied to intelligent vehicle finding at a vehicle owner terminal. The vehicle owner terminal is a terminal held by a vehicle owner. A vehicle finding application is downloaded from the vehicle owner terminal and the target vehicle, and the vehicle owner terminal and the target vehicle are bound. For example, the vehicle owner terminal and the vehicle finding application in the target vehicle are logged in by using the license plate number of the target vehicle to bind the vehicle owner terminal and the target vehicle by using the license plate number of the target vehicle. The target vehicle may transmit parking information to the vehicle owner terminal as vehicle finding guidance information, and the vehicle owner terminal may display the vehicle finding guidance information in the vehicle finding application. For a vehicle finding guidance interface of the vehicle owner terminal, refer to FIG. 13. The vehicle owner terminal displays parking space information, parking lot information, and a vehicle finding control set in the vehicle finding guidance interface. The parking space information includes a parking space identifier and a parking space image that correspond to the target vehicle, the parking lot information includes a parking lot and a parking floor that correspond to the target vehicle, and the vehicle finding control set includes a video playback control configured for playing a parking video in the vehicle finding guidance information, a parking fee payment control configured for paying a parking fee, and a parking sharing control configured for sharing the vehicle finding guidance information.

In a specific embodiment, the method of this application may be applied to intelligent vehicle finding based on a social application in a vehicle owner terminal. A social application is installed in the vehicle owner terminal, and a vehicle finding official account in the social application is associated with a vehicle finding mini program in the social application. The vehicle owner follows the vehicle finding official account in the social application, and logs in to the vehicle finding mini program and a vehicle finding application in the target vehicle by using the license plate number of the target vehicle. The target vehicle may determine parking information of the target vehicle by using the preset state machine, use the parking information as vehicle finding guidance information, and transmit the vehicle finding guidance information to the vehicle owner terminal. When the vehicle owner terminal receives the vehicle finding guidance information of the target vehicle, the vehicle owner terminal presents a parking notification corresponding to the target vehicle in the vehicle finding official account. After a user clicks the parking notification, the vehicle owner terminal enters a vehicle finding mini program, and displays detailed vehicle finding guidance information in the vehicle finding mini program. A vehicle finding guidance function is integrated in the social application, so that the vehicle finding efficiency can be effectively improved.

Operations in flowcharts involved in the foregoing embodiments are shown sequentially based on indication of arrows, but the operations are not necessarily performed sequentially based on a sequence indicated by the arrows. Unless otherwise explicitly specified in this application, execution of the operations is not strictly limited, and the operations may be performed in other sequences. Moreover, at least some of the operations in the flowcharts involved in the foregoing embodiments may include a plurality of operations or a plurality of stages. These operations or stages are not necessarily performed at the same time, but may be performed at different times. These operations or stages are not necessarily performed in sequence, but may be performed in turn or in alternation with other operations or at least some of the operations or stages in other operations.

Embodiments of this application further provide a vehicle data processing apparatus configured to implement the foregoing vehicle data processing method. Implementation solutions provided by the apparatus for resolving problems are similar to the implementation solutions described in the foregoing method. Therefore, specific limitations in one or more embodiments of the vehicle data processing apparatus provided below may refer to the limitations on the vehicle data processing method in the foregoing descriptions. Details are not described herein again.

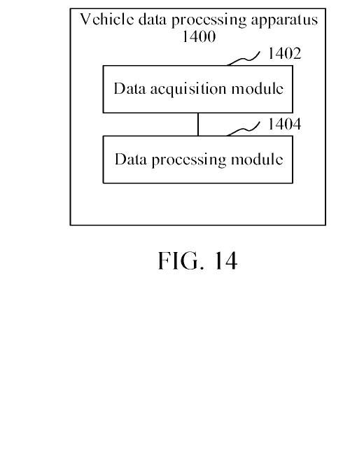

In an embodiment, as shown in FIG. 14, a vehicle data processing apparatus 1400 is provided, including: a data acquisition module 1402 and a data processing module 1404, where:

the data acquisition module 1402 is configured to input a sensor signal generated by a vehicle sensor of a target vehicle to a preset state machine, the preset state machine including a logical relationship among a plurality of vehicle states; and

the data processing module 1404 is configured to update, in a current vehicle state of the target vehicle, a shared signal set based on a received sensor signal by using the preset state machine, determine a next vehicle state of the target vehicle based on a current shared signal set, and switch from the current vehicle state to the next vehicle state, the shared signal set including sensor signals shared by vehicle states.

The data processing module 1404 is further configured to update, when switching to a target parking state, a private signal set corresponding to the target parking state based on the received sensor signal by using the preset state machine, and determine parking information of the target vehicle based on the current shared signal set and a current private signal set, the parking information being configured as vehicle finding guidance information of the target vehicle.

In an embodiment, the data processing module 1404 is further configured to:

add a received vehicle positioning signal to a vehicle positioning signal sequence in the shared signal set, and add a received vehicle motion signal to a vehicle motion signal sequence in the shared signal set;

add a received vehicle front-camera image meeting a first preset condition to a vehicle camera image sequence in the shared signal set; and

add a plurality of received sensor signals meeting a second preset condition to a mixed signal sequence in the shared signal set.

In an embodiment, the data processing module 1404 is further configured to:

update a accumulated vehicle mileage value of a first vehicle odometer in the shared signal set based on a received speed sensor signal;

add, when the accumulated vehicle mileage value of the first vehicle odometer is greater than a first preset threshold, a currently received vehicle front-camera image to the vehicle camera image sequence in the shared signal set, and reset the accumulated vehicle mileage value of the first vehicle odometer; and

delete, when a quantity of images in the vehicle camera image sequence is greater than a second preset threshold, images from the vehicle camera image sequence in a forward order of image acquisition time.

In an embodiment, the data processing module 1404 is further configured to:

input, when the current vehicle state of the target vehicle is not a stopping state and a sensor signal indicating a vehicle stop is not received, the mixed signal sequence in the current shared signal set to a parking lot access identification model to obtain a predicted vehicle state, and use the predicted vehicle state as a next vehicle state of the target vehicle, the predicted vehicle state being an indoor parking state or an outdoor state;

determine, when the sensor signal indicating a vehicle stop is received, that the next vehicle state of the target vehicle is the stopping state; and

determine, when a sensor signal indicating a vehicle start is received in the stopping state, that the next vehicle state of the target vehicle is a starting state.

In an embodiment, the data processing module 1404 is further configured to:

update, when switching to the indoor parking state, a vehicle parking state in the private signal set corresponding to the indoor parking state based on a received vehicle gear signal, the indoor parking state being the target parking state;

update, when the vehicle parking state is a forward state, the vehicle camera image sequence in the shared signal set based on the received vehicle front-camera image;

update, when the vehicle parking state is a reverse state, the vehicle camera image sequence in the shared signal set and a vehicle rear-camera image sequence in the private signal set based on a received vehicle rear-camera image; and

identify, when the sensor signal indicating a vehicle stop is received, a parking space based on a current vehicle rear-camera image sequence to obtain a parking space corresponding to the target vehicle, identify a parking floor based on a current vehicle motion signal sequence to obtain a parking floor corresponding to the target vehicle, determine a parking lot corresponding to the target vehicle based on a current vehicle positioning signal sequence, and obtain parking information of the target vehicle in the indoor parking state based on the parking space, the parking floor and the parking lot corresponding to the target vehicle and a current vehicle camera image sequence.

In an embodiment, the data processing module 1404 is further configured to:

add a received vehicle rear-camera image to the vehicle camera image sequence in the shared signal set;

update a accumulated vehicle mileage value of a second vehicle odometer in the private signal set based on a received speed sensor signal; and

add, when the accumulated vehicle mileage value of the second vehicle odometer is greater than a third preset threshold and a vacant parking space is available within a preset range of the target vehicle, a currently received vehicle rear-camera image to the vehicle rear-camera image sequence in the private signal set, and reset the second vehicle odometer.

In an embodiment, the data processing module 1404 is further configured to:

perform character recognition on the vehicle rear-camera image added to the vehicle rear-camera image sequence in the private signal set to obtain a parking space identifier corresponding to the vehicle rear-camera image and recognition confidence;

select vehicle rear-camera images having recognition confidence greater than preset confidence as candidate rear-camera images from the current vehicle rear-camera image sequence;

compute parking space identifier similarity among the candidate rear-camera images based on parking space identifiers corresponding to the candidate rear-camera images;

determine a target rear-camera image from the candidate rear-camera images based on the parking space identifier similarity; and

determine a parking space corresponding to the target vehicle based on a parking space identifier corresponding to the target rear-camera image.

In an embodiment, the data processing module 1404 is further configured to:

determine a vehicle front driving angle sequence of the target vehicle based on an IMU signal in a current vehicle motion signal sequence, and determine a driving speed sequence of the target vehicle based on a speed sensor signal in the current vehicle motion signal sequence; and

determine a parking floor corresponding to the target vehicle based on the vehicle front driving angle sequence and the driving speed sequence of the target vehicle.

In an embodiment, the data processing module 1404 is further configured to:

acquire a vehicle positioning signal having signal strength greater than preset strength in a reverse order of signal generation time from a current vehicle positioning signal sequence as a target positioning signal; and

use a point of interest corresponding to the target positioning signal as a parking lot corresponding to the target vehicle.

In an embodiment, the data processing module 1404 is further configured to:

update, when the vehicle parking state is updated from the forward state to the reverse state, a accumulated vehicle mileage value of a third vehicle odometer in the private signal set based on a received speed sensor signal, the third vehicle odometer being configured to collect statistics on a accumulated vehicle mileage value from a time when the target vehicle enters the indoor parking state to a time when the target vehicle stops reversing last time;

clear, when a difference between a current accumulated vehicle mileage value and a historical accumulated vehicle mileage value of the third vehicle odometer is greater than a fourth preset threshold, the vehicle rear-camera image sequence in the private signal set; and

clear, after the parking information of the target vehicle in the indoor parking state is determined, the vehicle positioning signal sequence and the vehicle camera image sequence in the current shared signal set and the vehicle rear-camera image sequence in the private signal set.

In an embodiment, the data processing module 1404 is further configured to:

determine, when the sensor signal indicating a vehicle stop is received, the parking lot corresponding to the target vehicle based on the vehicle positioning signal sequence in the current shared signal set by using the preset state machine in a case of switching to the outdoor state;

acquire a vehicle surround-view camera image; and

obtain parking information of the target vehicle in the outdoor state based on the parking lot corresponding to the target vehicle and the vehicle surround-view camera image.

In an embodiment, the data processing module 1404 is further configured to:

clear, after the parking information of the target vehicle in the outdoor state is determined by using the preset state machine, the vehicle positioning signal sequence, the vehicle motion signal sequence, and the vehicle camera image sequence in the current shared signal set.

In an embodiment, the data processing module 1404 is further configured to:

clear, when the next vehicle state is determined to be the indoor parking state or the outdoor state by using the preset state machine, the vehicle positioning signal sequence and the vehicle camera image sequence in the current shared signal set.

In an embodiment, the data processing module 1404 is further configured to:

acquire, when switching from the target parking state to a stopping state, the parking lot and parking start time corresponding to the target vehicle from the parking information corresponding to the target vehicle, and determine a parking fee surcharge reminder condition corresponding to the target vehicle based on the parking lot and the parking start time; and

generate, when parking duration of the target vehicle meets the parking fee surcharge reminder condition, a parking fee reminder notification corresponding to the target vehicle, the parking fee reminder notification being configured for being displayed on at least one of the target vehicle and a vehicle owner terminal corresponding to the target vehicle.

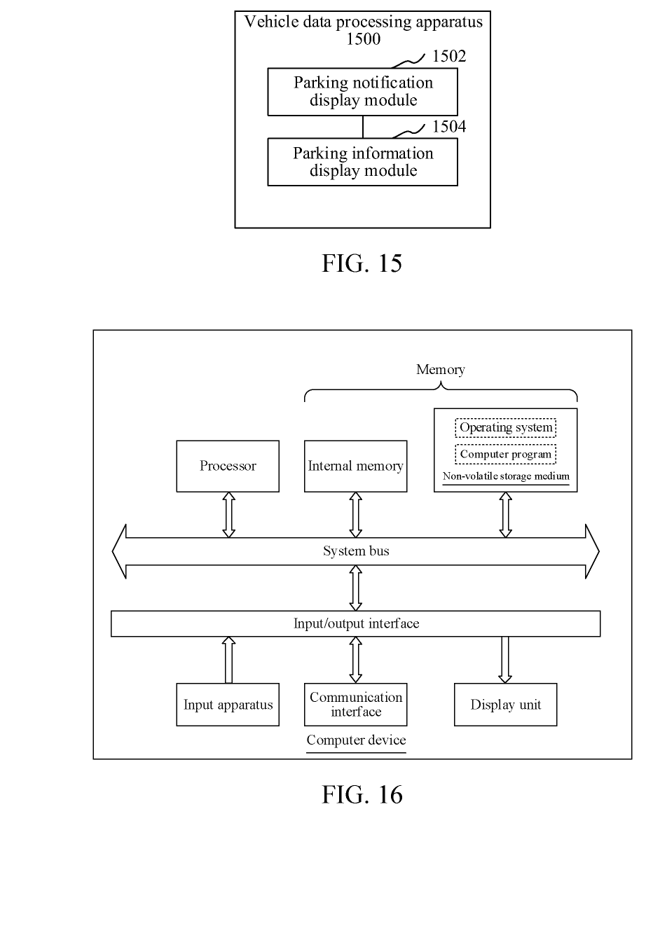

In an embodiment, as shown in FIG. 15, a vehicle data processing apparatus 1500 is provided, including: a parking notification display module 1502 and a parking information display module 1504, where:

the parking notification display module 1502 is configured to display a parking notification corresponding to a target vehicle; and

the parking information display module 1504 is configured to display, in response to a trigger event for the parking notification, vehicle finding guidance information of the target vehicle.

The vehicle finding guidance information is determined when switching to a target parking state, by updating a shared signal set and a private signal set corresponding to the target parking state based on a received sensor signal by using a preset state machine that controls vehicle state switching, and based on a current shared signal set and a current private signal set. The preset state machine includes a logical relationship among a plurality of vehicle states, and the shared signal set includes sensor signals shared by the vehicle states.

In an embodiment, the parking notification display module 1502 is further configured to display, when the target vehicle is switched from the target parking state to a stopping state, a parking notification corresponding to the target vehicle in a parent application.

The parking information display module 1504 is further configured to enter, in response to a trigger operation on the parking notification, a vehicle finding child application in the parent application, and display vehicle finding guidance information of the target vehicle in the vehicle finding child application.

In an embodiment, the parking information display module 1504 is further configured to:

display, in a parking space guidance area in the vehicle finding guidance interface, parking space information in the vehicle finding guidance information of the target vehicle, the parking space information including at least one of a parking space identifier and a parking space image corresponding to the target vehicle;

display, in a parking lot guidance area in the vehicle finding guidance interface, parking lot information in the vehicle finding guidance information of the target vehicle, the parking lot information including at least one of a parking lot and a parking floor corresponding to the target vehicle; and

display a vehicle finding control set in an operation function area in the vehicle finding guidance interface, the vehicle finding control set including at least one of a video playback control configured for playing a parking video in the vehicle finding guidance information of the target vehicle, a parking fee payment control configured for paying a parking fee, and a parking sharing control configured for sharing the vehicle finding guidance information of the target vehicle.

In an embodiment, the parking information display module 1504 is further configured to:

display a video playback control;

play, in response to a trigger operation on the video playback control, a parking video formed based on a vehicle camera image sequence in the vehicle finding guidance information of the target vehicle;

highlight a playback area of the parking video when the parking video is played;

display a video turn-off control when the parking video is played; and

cancel, in response to a trigger operation on the video turn-off control, playing of the parking video.

In an embodiment, the parking information display module 1504 is further configured to:

display a parking fee payment control;

display, in response to a trigger operation on the parking fee payment control, a payment graphic code corresponding to the parking lot in the vehicle finding guidance information of the target vehicle; and

transfer, in response to a trigger operation on the payment graphic code, a parking fee corresponding to the target vehicle to a parking fee account corresponding to the parking lot in the vehicle finding guidance information of the target vehicle.

In an embodiment, the parking information display module 1504 is further configured to:

display a parking fee surcharge setting entrance;

display, in response to a trigger operation on the parking fee surcharge setting entrance, a parking fee surcharge reminder attribute; and

update and display, in response to an editing operation on the parking fee surcharge reminder attribute, the parking fee surcharge reminder attribute as a parking fee surcharge reminder attribute edited through the editing operation, so that the parking fee surcharge reminder condition of the target vehicle is updated to an edited parking fee surcharge reminder attribute.

In the foregoing vehicle data processing apparatus, the preset state machine includes a logical relationship among a plurality of vehicle states, and can intelligently analyze sensor signals generated in real time by a vehicle to switch the vehicle states and determine parking information, thereby improving the efficiency of determining parking information. The preset state machine determines the next vehicle state of the target vehicle based on sensor signals shared by the vehicle states, switches from the current vehicle state to the next vehicle state, and in a process of switching to the target parking state, determines parking information of the target vehicle based on the sensor signals shared by the vehicle states and sensor signals private to the target parking state. Vehicle state switching can be flexibly performed and vehicle finding guidance information can be quickly and accurately determined by using the shared signal set and the private signal set corresponding to the target parking state, thereby effectively improving vehicle finding efficiency and ensuring vehicle finding accuracy.

All the modules in the foregoing vehicle data processing apparatus may be partially or completely implemented through software, hardware, or any combination thereof. All the modules may be embedded in or independent of a processor in a computer device in a form of hardware, or may be stored in a memory in a computer device in a form of software, such that the processor may invoke and execute operations corresponding to the modules.

In an embodiment, a computer device is provided. The computer device may be a terminal. An internal structural diagram of the computer device may be shown in FIG. 16. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and computer-readable instructions stored therein. The internal memory provides an environment for running the operating system and the computer-readable instructions in the non-volatile storage medium. The input/output interface of the computer device is configured to exchange information between the processor and an external device. The communication interface of the computer device is configured to conduct wired or wireless communication with an external terminal. The wireless communication may be implemented through wireless fidelity (WIFI), a mobile cellular network, near field communication (NFC), or another technology. The computer-readable instructions, when executed by the processor, implement a vehicle data processing method. The display unit of the computer device is configured to form a visually visible image, and may be a display screen, a projection apparatus, or a virtual reality imaging apparatus. The display screen may be a liquid crystal display screen or an electronic-ink display screen. The input apparatus of the computer device may be a touch layer covering the display screen, or may be a key, a trackball, or a touchpad arranged on a housing of the computer device, or may be an external keyboard, touchpad or mouse, or the like.

It may be understood by those skilled in the art that a structure shown in FIG. 16 is merely a block diagram of part of a structure related to a solution of this application, and does not constitute a limitation to the computer device to which the solution of this application is applied. Specific computer devices may include more or less components than those shown in the figure, or some components may be combined, or different component arrangements are provided.

In an embodiment, a computer device is further provided, including a memory and a processor, the memory having computer-readable instructions stored therein, the processor, when executing the computer-readable instructions, implementing operations in the foregoing method embodiments.

In an embodiment, a computer-readable storage medium is provided, having computer-readable instructions stored therein, the computer-readable instructions, when executed by a processor, implementing operations in the foregoing method embodiments.

In an embodiment, a computer program product is provided, including computer-readable instructions, the computer-readable instructions, when executed by a processor, implementing operations in the foregoing method embodiments.

User information (including, but not limited to, user equipment information, user personal information, and the like) and data (including, but not limited to, data for analysis, stored data, displayed data, and the like) involved in this application are both information and data that are authorized by a user or fully authorized by all parties. Collection, use, and processing of related data need to comply with relevant regulations.

A person of ordinary skill in the art may understand that all or some of the procedures of the methods of the foregoing embodiments may be implemented by using computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database or other media used in all the embodiments provided by this application may include at least one of a non-volatile memory and a volatile memory. The non-volatile memory may include a read‑only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache memory, or the like. For the purpose of illustration rather than limitation, the RAM may be in various forms, such as a static random access memory (SRAM), or a dynamic random access memory (DRAM). The database involved in the embodiments provided in this application may include at least one of a relational database and a non-relational database. The non-relational database may include a distributed database based on a block chain, and is not limited thereto. The processor involved in the embodiments provided in this application may be a general purpose processor, a central processing unit, a graphic processing unit, a digital signal processor, a programmable logic unit, a data processing logic unit based on quantum computing, and the like, and is not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims.

What is claimed is:

1. A vehicle data processing method, applied to a computer device, and comprising:
inputting a sensor signal generated by a vehicle sensor of a target vehicle to a preset state machine, the preset state machine comprising a logical relationship among a plurality of vehicle states;
updating a shared signal set based on a received sensor signal by using the preset state machine in a current vehicle state of the target vehicle, determining a next vehicle state of the target vehicle based on a current shared signal set, and switching from the current vehicle state to the next vehicle state, the shared signal set comprising sensor signals shared by vehicle states; and
updating a private signal set corresponding to the target parking state based on the received sensor signal by using the preset state machine when switching to a target parking state, and determining parking information of the target vehicle based on the current shared signal set and a current private signal set, the parking information being configured as vehicle finding guidance information of the target vehicle.

2. The method according to claim 1, wherein the updating a shared signal set based on the received sensor signal comprises:
adding a received vehicle positioning signal to a vehicle positioning signal sequence in the shared signal set, and adding a received vehicle motion signal to a vehicle motion signal sequence in the shared signal set;
adding a received vehicle front-camera image meeting a first preset condition to a vehicle camera image sequence in the shared signal set; and
adding a plurality of received sensor signals meeting a second preset condition to a mixed signal sequence in the shared signal set.

3. The method according to claim 2, wherein the adding a received vehicle front-camera image meeting a first preset condition to a vehicle camera image sequence in the shared signal set comprises:
updating an accumulated vehicle mileage value of a first vehicle odometer in the shared signal set based on a received speed sensor signal;
adding a currently received vehicle front-camera image to the vehicle camera image sequence in the shared signal set when the accumulated vehicle mileage value of the first vehicle odometer is greater than a first preset threshold, and resetting the accumulated vehicle mileage value of the first vehicle odometer; and
deleting images from the vehicle camera image sequence in a forward order of image acquisition time when a quantity of images in the vehicle camera image sequence is greater than a second preset threshold.

4. The method according to claim 1, wherein the determining a next vehicle state of the target vehicle based on a current shared signal set comprises:
inputting the mixed signal sequence in the current shared signal set to a parking lot access identification model to obtain a predicted vehicle state when the current vehicle state of the target vehicle is not a stopping state and a sensor signal indicating a vehicle stop is not received, and using the predicted vehicle state as a next vehicle state of the target vehicle, the predicted vehicle state being an indoor parking state or an outdoor state;
determining that the next vehicle state of the target vehicle is the stopping state when the sensor signal indicating a vehicle stop is received; and
determining that the next vehicle state of the target vehicle is a starting state when a sensor signal indicating a vehicle start is received in the stopping state.

5. The method according to claim 1, wherein the updating a private signal set corresponding to the target parking state based on the received sensor signal when switching to a target parking state, and determining parking information of the target vehicle based on the current shared signal set and a current private signal set comprises:
updating a vehicle parking state in the private signal set corresponding to the indoor parking state based on a received vehicle gear signal, the indoor parking state being the target parking state;
updating the vehicle camera image sequence in the shared signal set based on the received vehicle front-camera image when the vehicle parking state is a forward state,;
updating the vehicle camera image sequence in the shared signal set and a vehicle rear-camera image sequence in the private signal set based on a received vehicle rear-camera image; and
identifying a parking space based on a current vehicle rear-camera image sequence to obtain a parking space corresponding to the target vehicle when the sensor signal indicating a vehicle stop is received,, identifying a parking floor based on a current vehicle motion signal sequence to obtain a parking floor corresponding to the target vehicle, determining a parking lot corresponding to the target vehicle based on a current vehicle positioning signal sequence, and obtaining parking information of the target vehicle in the indoor parking state based on the parking space, the parking floor and the parking lot corresponding to the target vehicle and a current vehicle camera image sequence.

6. The method according to claim 5, wherein the updating the vehicle camera image sequence in the shared signal set and a vehicle rear-camera image sequence in the private signal set based on a received vehicle rear-camera image comprises:
adding the received vehicle rear-camera image to the vehicle camera image sequence in the shared signal set;
updating a accumulated vehicle mileage value of a second vehicle odometer in the private signal set based on the received speed sensor signal; and
adding a currently received vehicle rear-camera image to the vehicle rear-camera image sequence in the private signal set when the accumulated vehicle mileage value of the second vehicle odometer is greater than a third preset threshold and a vacant parking space is available within a preset range of the target vehicle, and resetting the second vehicle odometer.

7. The method according to claim 5, further comprising:
performing character recognition on the vehicle rear-camera image added to the vehicle rear-camera image sequence in the private signal set to obtain a parking space identifier corresponding to the vehicle rear-camera image and recognition confidence;
the identifying a parking space based on a current vehicle rear-camera image sequence to obtain a parking space corresponding to the target vehicle comprising:
selecting vehicle rear-camera images having recognition confidence greater than preset confidence as candidate rear-camera images from the current vehicle rear-camera image sequence;
computing parking space identifier similarity among the candidate rear-camera images based on parking space identifiers corresponding to the candidate rear-camera images;
determining a target rear-camera image from the candidate rear-camera images based on the parking space identifier similarity; and
determining a parking space corresponding to the target vehicle based on a parking space identifier corresponding to the target rear-camera image.

8. The method according to claim 5, wherein the identifying a parking floor based on a current vehicle motion signal sequence to obtain a parking floor corresponding to the target vehicle comprises:
determining a vehicle front driving angle sequence of the target vehicle based on an inertial measurement unit signal in a current vehicle motion signal sequence, and determining a driving speed sequence of the target vehicle based on a speed sensor signal in the current vehicle motion signal sequence; and
determining the parking floor corresponding to the target vehicle based on the vehicle front driving angle sequence and the driving speed sequence of the target vehicle.

9. The method according to claim 5, wherein the determining a parking lot corresponding to the target vehicle based on a current vehicle positioning signal sequence comprises:
acquiring a vehicle positioning signal having signal strength greater than preset strength in a reverse order of signal generation time from the current vehicle positioning signal sequence as a target positioning signal; and
using a point of interest corresponding to the target positioning signal as the parking lot corresponding to the target vehicle.

10. The method according to claim 5, further comprising:
Updating an accumulated vehicle mileage value of a third vehicle odometer in the private signal set based on the received speed sensor signal when the vehicle parking state is updated from the forward state to the reverse state, the third vehicle odometer being configured to collect statistics on a accumulated vehicle mileage value from a time when the target vehicle enters the indoor parking state to a time when the target vehicle stops reversing last time;
clearing the vehicle rear-camera image sequence in the private signal set when a difference between a current accumulated vehicle mileage value and a historical accumulated vehicle mileage value of the third vehicle odometer is greater than a fourth preset threshold; and
clearing the vehicle positioning signal sequence and the vehicle camera image sequence in the current shared signal set and the vehicle rear-camera image sequence in the private signal set after the parking information of the target vehicle in the indoor parking state is determined.

11. The method according to claim 1, further comprising:
determining the parking lot corresponding to the target vehicle based on the vehicle positioning signal sequence in the current shared signal set by using the preset state machine when switching to the outdoor state and receiving the sensor signal indicating a vehicle stop;
acquiring a vehicle surround-view camera image; and
obtaining parking information of the target vehicle in the outdoor state based on the parking lot corresponding to the target vehicle and the vehicle surround-view camera image.

12. The method according to claim 11, further comprising:
clearing the vehicle positioning signal sequence, the vehicle motion signal sequence, and the vehicle camera image sequence in the current shared signal set after the parking information of the target vehicle in the outdoor state is determined by using the preset state machine.

13. The method according to claim 1, further comprising:
clearing the vehicle positioning signal sequence, and the vehicle camera image sequence in the current shared signal set when the next vehicle state is determined to be the indoor parking state or the outdoor state by using the preset state machine.

14. The method according to claim 1, further comprising:
acquiring the parking lot and parking start time corresponding to the target vehicle from the parking information corresponding to the target vehicle when switching from the target parking state to the stopping state, and determining a parking fee surcharge reminder condition corresponding to the target vehicle based on the parking lot and the parking start time; and
generating a parking fee reminder notification corresponding to the target vehicle when parking duration of the target vehicle meets the parking fee surcharge reminder condition, the parking fee reminder notification being configured for being displayed on at least one of the target vehicle and a vehicle owner terminal corresponding to the target vehicle.

15. A vehicle data processing method, applied to a terminal, and comprising:
displaying a parking notification corresponding to a target vehicle; and
displaying vehicle finding guidance information of the target vehicle in response to a trigger event for the parking notification;
the vehicle finding guidance information being determined when switching to a target parking state, by updating a shared signal set and a private signal set corresponding to the target parking state based on a received sensor signal by using a preset state machine that controls vehicle state switching, and based on a current shared signal set and a current private signal set, the preset state machine comprising a logical relationship among a plurality of vehicle states, and the shared signal set comprising sensor signals shared by the vehicle states.

16. The method according to claim 15, wherein the displaying a parking notification corresponding to a target vehicle comprises:
displaying a parking notification corresponding to the target vehicle in a parent application when the target vehicle is switched from the target parking state to a stopping state; and
the displaying vehicle finding guidance information of the target vehicle in response to a trigger event for the parking notification, comprises:
entering a vehicle finding child application in the parent application, and displaying vehicle finding guidance information of the target vehicle in a vehicle finding guidance interface of the vehicle finding child application.

17. The method according to claim 15, wherein the displaying vehicle finding guidance information of the target vehicle comprises:
displaying parking space information in the vehicle finding guidance information of the target vehicle in a parking space guidance area in the vehicle finding guidance interface, the parking space information comprising at least one of a parking space identifier and a parking space image corresponding to the target vehicle;
displaying parking lot information in the vehicle finding guidance information of the target vehicle in a parking lot guidance area in the vehicle finding guidance interface, the parking lot information comprising at least one of a parking lot and a parking floor corresponding to the target vehicle; and
displaying a vehicle finding control set in an operation function area in the vehicle finding guidance interface, the vehicle finding control set comprising at least one of a video playback control configured for playing a parking video in the vehicle finding guidance information of the target vehicle, a parking fee payment control configured for paying a parking fee, and a parking sharing control configured for sharing the vehicle finding guidance information of the target vehicle.

18. The method according to claim 15, wherein the displaying vehicle finding guidance information of the target vehicle comprises:
displaying the video playback control;
playing a parking video formed based on a vehicle camera image sequence in the vehicle finding guidance information of the target vehicle in response to a trigger operation on the video playback control;
highlighting a playback area of the parking video when the parking video is played;
displaying a video turn-off control when the parking video is played; and
canceling playing of the parking video in response to a trigger operation on the video turn-off control.

19. The method according to claim 15, further comprising:
displaying the parking fee payment control;
displaying a payment graphic code corresponding to the parking lot in the vehicle finding guidance information of the target vehicle in response to a trigger operation on the parking fee payment control; and
transferring a parking fee corresponding to the target vehicle to a parking fee account corresponding to the parking lot in the vehicle finding guidance information of the target vehicle in response to a trigger operation on the payment graphic code.

20. A computer device, comprising a memory and a processor, the memory having computer-readable instructions stored therein, and the processor, when executing the computer-readable instructions, implementing operations in a vehicle data processing method comprising:
inputting a sensor signal generated by a vehicle sensor of a target vehicle to a preset state machine, the preset state machine comprising a logical relationship among a plurality of vehicle states;
updating a shared signal set based on a received sensor signal by using the preset state machine in a current vehicle state of the target vehicle, determining a next vehicle state of the target vehicle based on a current shared signal set, and switching from the current vehicle state to the next vehicle state, the shared signal set comprising sensor signals shared by vehicle states; and
updating a private signal set corresponding to the target parking state based on the received sensor signal by using the preset state machine when switching to a target parking state, and determining parking information of the target vehicle based on the current shared signal set and a current private signal set, the parking information being configured as vehicle finding guidance information of the target vehicle.
